(19) United States
(12) Patent Application Publication
(10) Pub. No.: US 2026/0004089 A1
(43) Pub. Date: Jan. 1, 2026

(54) Decoder Tool, System and Method for Deriving Divine Messaging

(71) Applicant: Don Karl Juravin, San Antonio, FL (US)

(72) Inventor: Don Karl Juravin, San Antonio, FL (US)

(21) Appl. No.: 19/308,719

(22) Filed: Aug. 25, 2025

Related U.S. Application Data
(63) Continuation-in-part of application No. 18/092,269, filed on Dec. 31, 2022, now Pat. No. 12,400,087.
(63) Continuation-in-part of application No. 18/092,272, filed on Dec. 31, 2022.

(51) Int. Cl. G06F 40/47; G06F 9/451; G06F 40/279; G06F 40/53

(52) U.S. Cl. CPC G06F 40/47; G06F 9/451; G06F 40/279; G06F 40/53

(57) ABSTRACT

A decoder tool, system and method helps a user derive secondary meaning from an original Hebrew bible letter string. A primary sequence of letters is arranged devoid of spaces and punctuation to form the bible letter string. Each letter is associated with a numerical letter value. Reference words or phrases are also identified within the bible string, each of which correspond to a primary word or phrase value. The primary word value is correlated with at least one other secondary word value, which secondary word value is equated to the primary word value. The primary meaning of the reference word or phrase can then be interpreted in view of the at least one secondary word value, and the at least one secondary word value is associated with at least one secondary meaning for bolstering an understanding of the primary meaning.

### PRIOR HISTORY

This application is a Continuation-in-Part patent application claiming the benefit of U.S. patent application Ser. No. 18/092,269 filed in the United States Patent and Trademark Office on 31 Dec. 2022 and U.S. patent application Ser. No. 18/092,272 filed in the United States Patent and Trademark Office on 31 Dec. 2022, the specifications and drawings of which are hereby incorporated by reference.

### BACKGROUND OF THE INVENTION

### Field of the Invention

The present invention generally relates to a system and method for enabling a user who can read the ancient Bible in Hebrew, and who has a deep understanding of the current Hebrew language, to derive secondary meaning from the Bible that can be attributed to God's messaging to humanity.

### Brief Description of the Prior Art

Gematria is the practice of assigning a numerical value to a name, word or phrase according to an alphanumerical cipher. A single word can yield several values depending on the cipher used. Hebrew alphanumeric ciphers have been reportedly in use for centuries, and were later adopted by other cultures. Gematria sums can involve single words, or a string of lengthy calculations. A well-known short example of Hebrew numerology that uses a gematria cipher is the Hebrew word, “ [symbol] ” or “chai” or in English, “alive”, which is composed of two Hebrew letters, “ [symbol] =8” and “′=10” that sum to 18. This particular numerical value in the Jewish tradition has been understood to convey the concept of “being alive”.

The following specifications show that the Original Bible is written in the Hebrew language and is first presented as a single string or thread of 1,197,000 of the twenty-two Hebrew letters for supporting these specifications. The Original Bible is in Hebrew and has never changed with 1,197,000 Hebrew letters and that all other “bibles” are a translation of the original. This is important for purposes of these specifications because the decoding system or code2GOD system and method according to the present invention only works with the original Hebrew bible letter string. While the Original Bible in Hebrew opens as follows: [symbol] [symbol] [symbol] [symbol] [symbol]
“ . . . [symbol] [symbol] [symbol]
   it can be better understood by the following example in English:
“IngenesisGodbroughtintoexistencetheskiesandthelandandtheearthwaswithoutformandvoi danddarknesswasuponthefaceofthedeepandtheSpiritofGodmoveduponthefaceofthewaters . . . ”

The original Hebrew Bible has been divided into books, chapters, and verses with punctuation and spacing added for enhancing comprehensibility of the Bible. More particularly, the original Hebrew Bible was initially divided into 24 books. Later, the original Hebrew Bible was further divided 39 books and 929 chapters, and both versions were normally read by both those of Christianity and Judaism traditions. Nevertheless, the original Hebrew Bible has remained intact and can be referenced by those wishing to develop a fuller understanding of the Bible as originally presented in the Hebrew language.

The original Hebrew Bible, when presented in a single continuous letter string according to these specifications comprises or provides primary messaging to decoders, but also comprises certain secondary messaging to decoders based on a number of mathematical methodologies according to the present invention that build upon the general principles of the gematria tradition. These methodologies are hereinafter referred to as code2GOD methods for brevity and ease of understanding. The omission or replacement of a single Hebrew letter of the original Hebrew bible letter string alters secondary or code2GOD meaning derivable from the original Hebrew bible letter string. The code2GOD system and method according to the present invention is provided for those who can read Hebrew and who have an understanding of original Hebrew scripture and an ability to decode the Bible utilizing the code2GOD methodologies more particularly described hereinafter.

The original Hebrew Bible may be preferably provided in a single continuous string of 1,197,000 Hebrew letters devoid of spaces and punctuation as derived from the original Hebrew Bible hereinafter referred to as the original Hebrew bible letter string. The original Hebrew scripture was written under strict rules on Kosher leather parchments to create the Original Bible scrolls, which were preserved for thousands of years, and did separate original scripture into separate words and paragraphs to enhance comprehensibility thereof. The author of the present specifications was the first ever to present this original Hebrew bible letter string comprising exactly 1,197,000 Hebrew letters devoid of spaces and punctuation as the one Word of God or as authorship of an intelligent designer of life. The Word of God that forms the basis of these specifications is one string of 1,197,000 Hebrew letters devoid of spaces and punctuation that is coded with GOD's messaging to humanity, but is not convenient to read. The author created the Original Bible by adding spaces to distinguish the 305,490 words and create 23,206 verses. This Original Bible format complies with the traditional 929 chapters divided 39 books as created by Christians and Jews.

There are many who have developed a familiarity with the populous bible of King James. The King James bible was developed at a point in time with translated material with intentional misinterpretations and supported by creative writing that operated to introduce foreign concepts to the original Hebrew Bible with a view toward adding flair and dramatization to pique readers' interest in the Bible. For example, the concepts of “heaven,” “hell,” and “unicorns,” neither appear in the original Hebrew Bible nor exist in their applied meaning and can often lead to a misunderstanding of originally written Hebrew Bible. The original Hebrew bible letter string can be read in a number of ways that include (1) simple stories, (2) parables used to illustrate a moral or spiritual lesson, and (3) coded messaging to decoders all of which can be variously interpreted for (a) enhancing human success and (b) developing a deeper understanding of the meaning of life.

The original Hebrew Bible can, of course, be translated into any language in the world. Original primary meaning as set forth in the original Hebrew bible letter string loses some of the original or primary meaning when so translated. The parables can only be translated into other languages in a limited, narrowed manner, and may not be properly understood as the original Author or intelligent designer intended them to be. For example, the names Cain and Abel are two terms representing the inner human struggle of balance between pursuing materialistic and spiritual lives. The English name, “Cain” is an equivalent of the Hebrew name, “Kain ( [symbol] )” and is a derivative of property and has a word value of 160, like the Hebrew term for money, “kesef.” ( [symbol] )

The English name, Abel is an equivalent of the Hebrew name, “Hevel ( [symbol] )” and represents the human spirit as the name means the steam, or spirit, that comes out of the human breath and has a word value of 37, which is equivalent to the human body temperature in degrees Celsius. The word value of 37 can then be used to equate this Hebrew term to peripheral factors in the human existence and thereby a decoder can derive secondary meaning or code2GOD meaning from original scripture. It is further noted the Hebrew name or term, “Hevel ( [symbol] )” comprises the first letter in the original Hebrew bible letter string, “ [symbol] ” and the last letter in the original Hebrew bible letter string, “ [symbol] ” and can also stand for the entire original Hebrew bible letter string. Relative positions of value-based Hebrew letters within the original Hebrew bible letter string can be used to derive further code2GOD or secondary meaning/messaging from the said scripture.

In the foregoing example of the Cain and Abel biblical story, the story as variously translated, can be understood as illustrating a certain jealousy between the two brothers. The parable as told in the original Hebrew scripture may be explained as follows: Cain is “Kain” or “ [symbol] ” in Hebrew and has a word value of 160 which numerical value stands for property, which is also the word value for money or “ [symbol] ” in Hebrew. Abel is “Hevel” or “ [symbol] ” in Hebrew and has a word value of 37 which name stands for the human spirit. The parable can thus be viewed as explanatory of the constant struggle for human balance between a materialistic life and the need for spirituality.

Having considered the pertinent prior art relating to methodologies for deriving secondary meaning from original scripture, the prior art perceives a need for applying coded messaging from the original Hebrew bible letter string. In other words, the prior art appears to be silent on an instructional document that assembles derivable codes inherent to the original Hebrew Bible into one instructional document. No prior art teaching has described a Chosen One or interpreter, which is the critical human factor for understanding complete exhaustive messaging to humanity. Without a Chosen One or interpreter feature, codes inherent to the original Hebrew bible letter string cannot be properly applied to understand the meaning of life and its improvement.

### SUMMARY OF THE INVENTION

The system and method according to the present invention, otherwise referred to as “code2GOD” comprises 32 mathematical or algorithmic methods. Their bases are Code Nos. 1 and 2 which are gematria based and derived from the prior art. Sine the codes lead to more advanced scientific and social data than is made available by way of commonly accepted scientific practices, it must be assumed that the creator of the original Hebrew Bible is God or an intelligent designer, and he/she assigned the original numerical values to the series of Hebrew letters that make up the Hebrew alphabet. Furthermore, each of the 22 biblical Hebrew letters is assigned two unique numbers between 1 and 510, and not simply 1 to 22, which is a range of values much more complex and supportive of the code2GOD methodologies that evidences the “language of God”. When combining the facts that (1) the code2GOD reveals advanced coded data and (2) the assigned values to the Hebrew letters is statistically complex leads to a conclusion that the originator is a divine entity or intelligent designer.

The present invention essentially provides a system and method, optionally implemented by at least one computer and a non-transitory software-based application implementable by at least one computer for deriving secondary meaning or code2GOD meaning from a select letter string as exemplified by the original Hebrew bible letter string consisting of 1,197,000 Hebrew letters devoid of spaces and punctuation (i.e. the Word of God). When considered methodologically, the method may be said to essentially comprise a series of steps. When considered systemically, the system according to the present invention may be said to essentially comprise at least one computer and a non-transitory computer-implementable application for implementing the essential methodology. For example, a computer and software application implementable by the computer are preferably incorporated into the present invention for rendering Pi or π calculations which is an example of how the code2GOD verifies results.

The system/method according to the present invention enables a user to derive secondary or code2GOD meaning from the exemplary letter string and essentially comprises the step of firstly identifying a primary sequence of Hebrew letters. Each Hebrew letter within the primary sequence of Hebrew letters is associated with a select numerical letter value. The Hebrew letters within the primary sequence of Hebrew letters are arranged to form a select letter string as exemplified by the original Hebrew biblical string consisting of 1,197,000 Hebrew letters devoid of spaces and punctuation. The select letter string has a master string value equal to the sum of the select numerical letter values for each of the letters within the select letter string.

The code2GOD system/method further comprises the step of identifying at least one first word within the select letter string. The word values for each word found within the select letter string sum to the master string value, and respective words within the select letter string each have a substring value less than the master string value. Word values of select words may be correlated or loosely associated with other secondary or peripheral word values by way of the same or similar word values. The primary or face value meaning of firstly considered words can then be interpreted in the context of the secondary or peripheral word values for providing at least one secondary meaning of select words as compared to the primary or face value meaning(s) for bolstering an understanding of the primary meaning(s).

For example, a full anagram of a first select word will always have the same word value of the first select word. In other words, if the letters of the at least one first word are re-arranged to form at least one anagram word, the at least one anagram word comprises the select word value or at least two secondary sub word values if the first select word is re-arranged and broken into a series of anagram words derived from the first select word. The word values for the first select word and its anagram(s) may then be interpreted to further bolster an understanding of the primary meaning of the first select word by way of providing additional numerical information and attendant secondary messaging as derived from the original Hebrew bible letter string.

The code2GOD system/method according to the present invention may further comprise the step of coupling the first select word value to at least one second word value to form a sequence or series of word values, which respectively can provide tertiary meaning or additional secondary meaning as interpreted within the context of multiple word values. The first word value and the at least one second word value may be correlated or otherwise arithmetically operated by way of a select arithmetic operator as selected from the group consisting of addition, subtraction, division and multiplication functions. The select arithmetic operators essentially output an arithmetically-operated word value, which arithmetically-operated word value yields or provides at least one arithmetically-operated word meaning for providing additional secondary or code2GOD meaning.

The relative or absolute position of select letters within the primary sequence of Hebrew letters can be selected to form either a relative position word value or an absolute position word value. Similarly, word values may be characterized by select traits as selected from the group consisting of a mystery word value, a dominant word value, a meaningful word value, and a repetitive word value. The code2GOD system/method according to the present invention may further focus upon a select string of words as selected from a select portion of an opening stanza of the select letter string characterized by the original Hebrew bible letter string.

A first Hebrew letter from each Hebrew word of the select string of Hebrew words are associated with a first Hebrew letter value, and these first Hebrew letter values may be totaled or summed and further operated by dividing the total number of Hebrew letters for yielding a meaningful average numerical value, which meaningful average numerical value is substantially equal to 3.14 or π. This average numerical value, being substantially equal to the 3.14 or π, can provide additional secondary or code2GOD meaning for the select string of Hebrew words as selected from a select portion of an opening stanza of the select letter string as exemplified by the original Hebrew biblical string consisting of 1,197,000 Hebrew letters devoid of spaces and punctuation. Select Hebrew word values may also be logarithmically operated to the base of Euler's number e for providing a natural logarithm for select word values for deriving additional secondary or code2GOD meaning.

The code2GOD system/method according to the present invention may further involve the summation of select numerical letter values for each Hebrew letter in a select series of Hebrew letters to provide a single reduced numerical value. The single reduced numerical value can be identified as being either (a) between a range of values, the range of values being from 1 to 9; or (b) a select unique numerical value, the select unique numerical value being selected from the group consisting of 11, 22, 33, and 44. The single reduced numerical value can be used to derive additional secondary or code2GOD meaning for Hebrew words having the same or related reduced numerical values as so reduced.

The code2GOD system/method according to the present invention may further focus upon a series of factors that are utilized to operate upon a select letter sub-string within the select letter string. These series of factors may comprise or consist of acronym-forming letters; select intervals of letters; and directional movement within the select letter string, the series of factors for providing additional secondary or code2GOD meaning. It is contemplated that a computer and a software-based application may well provide the most efficient means for deriving secondary or code2GOD meaning from portions of the original Hebrew Biblical string very much akin to the manner in which genetic traits within human DNA are located and identified.

The code2GOD system/method according to the present invention may further focus upon the use of geometrical data to operate upon the select word value for providing additional secondary or code2GOD meaning. Geometrical data associated with the Star of David, for example, can be utilized to confirm the importance of the numerical values of 37 and 73. In this regard, it will be noted the Star of David Theorem is a mathematical result based on arithmetic properties of binomial coefficients, which binomial coefficients can be used to convey or derive secondary or code2GOD meaning from one or more select letter strings as exemplified by the original Hebrew biblical string or scripture.

The code2GOD system/method according to the present invention may further comprise the step of utilizing a select count factor to operate upon the select word value. The select count factor may be selected from the group consisting of a number of letters or letter number within a chosen letter string; a number of letters or letter number within related word strings; and a number of letters or letter number within a sentence. In this regard, it will be noted the number of singular word repetitions in the original Hebrew Bible string can provide meaningful word values. Further, matching the first and last letters of a Hebrew word with the first and last letters of a verse from the original Hebrew bible string provides information for deriving additional secondary or code2GOD meaning. Further, using prime or Fibonacci numbers to explain correlations between Hebrew words or verses provides information for deriving additional secondary or code2GOD meaning.

The code2GOD system/method according to the present invention may focus upon the fact that each Hebrew letter within the primary sequence of Hebrew letters comprises a unique size and shape. The unique size and shape of each Hebrew letter provides factor data, which factor data may be selected from the group consisting of letter termini data (i.e. number of letter end points); directional termini data (i.e. the number of letter end points in each of the four primary directions); and relative height-width data (the relative size of comparable Hebrew letters). The factor data can provide additional secondary or code2GOD meaning.

There is provided in accordance with a first aspect according to the presently disclosed subject matter a computer-implemented decoder tool for deriving divine messaging. The decoder tool comprises a computer-implementable software-based application, at least one computer, and a graphical user interface together being configured to compile a Hebrew bible letter string devoid of spaces and punctuation; enable a user to input a reference Hebrew word from within the Hebrew bible letter string, the reference Hebrew word having a primary meaning; output a primary word value associated with the reference Hebrew word; and correlate the primary word value with at least one secondary word value. A user is thereby enabled to interpret the primary meaning of the reference Hebrew word in view of the at least one secondary word value thereby providing at least one secondary meaning reflective of divine messaging from within the Hebrew bible letter string. The at least one secondary meaning bolsters an understanding of the primary meaning.

In some applications, at least one comparison Hebrew word is input for comparison to the reference Hebrew word. The computer-implementable software-based application, at least one computer, and the graphical user interface together being configured to: output a comparison word value associated with the at least one comparison Hebrew word; calculate and output a word difference value derived from the primary word value and the comparison word value; and associate the word difference value with at least one third Hebrew word. The user is thereby enabled to interpret the primary meaning of the reference Hebrew word in view of the comparison Hebrew word and the at least one third Hebrew word thereby providing tertiary meaning reflective of divine messaging from within the Hebrew bible letter string. The tertiary meaning bolsters an understanding of the primary meaning.

In some applications, the computer-implementable software-based application, at least one computer, and the graphical user interface are together configured to: calculate and output a word sum value derived from the primary word value and the comparison word value; and associate the word sum value with at least one fourth Hebrew word. The user is thereby enabled to interpret the primary meaning of the reference Hebrew word in view of the comparison Hebrew word and the at least one fourth Hebrew word thereby providing quaternary meaning reflective of divine messaging from within the Hebrew bible letter string. The quaternary meaning bolsters an understanding of the primary meaning.

In some applications, the reference Hebrew word consists of individual Hebrew letters such that the individual Hebrew letters are associated with a minimal letter value. The minimal letter values of each individual Hebrew letter within the reference Hebrew word are summed to provide a minimal number value upon the graphical user interface for bolstering an understanding of the primary meaning. In some applications, the individual Hebrew letters are associated with a letter name value. The letter name values of each individual Hebrew letter within the reference Hebrew word are summed to provide a first extended number value upon the graphical user interface for bolstering an understanding of the primary meaning.

In some applications, select Hebrew letters of the individual Hebrew letters are associated with a plurality of letter name values. The plurality of letter name values of the select Hebrew letters are summed with the first extended number value to provide a second extended number value upon the graphical user interface for bolstering an understanding of the primary meaning. In some applications, the decoder tool comprises a Pi locator feature associated with output number values corresponding to any one of the primary word value, the minimal number value, the first extended number value and the second extended number value. The Pi locator feature is selected to locate a select output number value from the output number values within the Pi string at a number location. The number location bolsters an understanding of the primary meaning.

In some applications, the decoder tool is configured to provide a lifepath output value. The lifepath output value is derived by summing Pi string digits from the number location along a string length equal to the select output number value. The lifepath output value bolsters an understanding of the primary meaning. In some applications, a select numerical letter value of each Hebrew letter in the reference Hebrew word is summed to provide a single reduced numerical value or ‘divine’ number value. In some applications, the single reduced numerical value is (a) between a range of values from 1 to 9; (b) equal to 10; or (c) a select unique numerical value selected from the group consisting of 11, 22, 33, and 44. In some applications, the single reduced numerical value is limited to the range of values from 1 to 9. The single reduced numerical value bolsters an understanding of the primary meaning.

In some applications, a verse from within the Hebrew bible letter string, and associated with the primary word value, is output upon the graphical user interface for bolstering an understanding of the primary meaning. In some applications, the decoder tool comprises a research results add feature configured to populate a research results compilation with the reference Hebrew word as associated with the primary word value for bolstering an understanding of the primary meaning. In some applications, a primary word value summary feature is configured to output all Hebrew words within the Hebrew bible letter string associated with the primary word value upon the graphical user interface for bolstering an understanding of the primary meaning.

There is provided in accordance with another aspect of the presently disclosed subject matter, a computer-implemented system for deriving divine messaging. The computer-implemented system comprises a computer-implementable software-based application; at least one computer; and a Hebrew bible letter string devoid of spaces and punctuation compiled by the computer-implementable software-based application and at least one computer. The computer-implementable software-based application and the at least one computer are configured to: identify a reference Hebrew word from within the Hebrew bible letter string, the reference Hebrew word comprising a reference word value and a primary meaning; correlate the reference word value with at least one other secondary word value; and enable a user to interpret the primary meaning of the reference Hebrew word in view of the at least one secondary word value. The at least one secondary word value provides at least one secondary meaning reflective of divine messaging from within the Hebrew bible letter string thereby bolstering an understanding of the primary meaning.

In some applications, the reference word value and the secondary word value are correlated by way of a select arithmetic operator. The select arithmetic operator is selected from the group consisting of addition, subtraction, division and multiplication. The select arithmetic operator outputs a combination word value, the combination word value for providing at least one arithmetically-operated word meaning for bolstering an understanding of the primary meaning. In some applications, the computer-implemented system comprises a Pi locator feature associated with at least one output number value. The Pi locator feature is selected to locate a select output number value within a Pi string at a number location for bolstering an understanding of the primary meaning. In some applications, the computer-implemented system comprises a primary word value summary feature configured to output all Hebrew words within the Hebrew bible letter string associated with the primary word value upon the graphical user interface for bolstering an understanding of the primary meaning.

There is provided in accordance with another aspect of the presently disclosed subject matter a computer-implemented method for deriving divine messaging. The computer-implemented method comprises the steps of: compiling a Hebrew bible letter string devoid of spaces and punctuation by a computer-driven decoder tool, each letter within the original Hebrew bible letter string being associated with a select numerical letter value; identifying by said decoder tool a reference Hebrew word within the original Hebrew bible letter string, the reference Hebrew word having a primary meaning; assigning by said decoder tool the reference Hebrew word with a reference word value; and correlating by said decoder tool the reference word value with at least one other secondary word value. A user is thereby enabled to interpret the primary meaning of the reference Hebrew word in view of the at least one secondary word value, which at least one secondary word value provides at least one secondary meaning reflective of divine messaging from within the Hebrew bible letter string for bolstering an understanding of the primary meaning.

In some applications, the reference word value and the secondary word value are correlated by way of a select arithmetic operator, the select arithmetic operator being selected from the group consisting of addition, subtraction, division and multiplication. The select arithmetic operator outputs a combination word value, which combination word value for providing at least one arithmetically-operated word meaning for bolstering an understanding of the primary meaning. In some applications, the computer-implemented method comprises the step of selecting a Pi locator feature of said decoder tool. The Pi locator feature is selected to locate a select output number value within a Pi string at a number location, which number location bolsters an understanding of the primary meaning. In some applications, the computer-implemented method comprises the step of outputting all Hebrew words within the Hebrew bible letter string associated with the reference word value upon a graphical user interface of the decoder tool for bolstering an understanding of the primary meaning.

### BRIEF DESCRIPTION OF DRAWINGS

Other features and objectives of the code2GOD decoder tool, system and method according to the present invention will become more evident from a consideration of the following brief descriptions of patent drawings.

FIG. 1 is a Prior Art table setting forth rows and columns of the Hebrew alphabet setting forth Hebrew letters, letter values for each Hebrew letter, letter nomenclature for each Hebrew letter and extended values for each letter nomenclature.

FIG. 2 is an example of how a word value may be associated with a Hebrew word according to the present invention; viewed from left to right is an exemplary English word, its Hebrew equivalent in the English language, its Hebrew equivalent in the Hebrew language, and a word value associated with the Hebrew word as derived from the numerical values associated with Hebrew letters set forth in FIG. 1.

FIG. 3A is a first example of a simple word value equation in which a first word value is arithmetically added to a second word value to yield a first sum or first total word value with an associated Hebrew word.

FIG. 3B is a second example of a simple word value equation in which the first word value is arithmetically added to the second word value and added to the first total word value otherwise depicted in FIG. 3A to yield a second sum or second total word value or combination word value with alternatively associated Hebrew words.

FIG. 3C is a third example of a simple word value equation in which a “mother” word value is arithmetically added to a “father” word value to yield a combination word value of 44, which word value may be alternatively associated with either of the words, “child” or “blood”.

FIG. 3D is a fourth example of a simple word value equation by which the Hebrew word for “available” is subtracted from the Hebrew word for “desired” to yield a difference word value of 160 corresponding to the Hebrew word for “money”.

FIG. 4 is a visual depiction of a parent letter string or word that may portioned to yield alternative child letter strings or words from the parent letter string or word.

FIG. 5 is a fifth example of a simple word value equation by which the Hebrew word for “bread” is subtracted from the Hebrew word for “war” to yield a difference word value of 45 corresponding to the Hebrew name for “Adam”.

FIG. 6 is an example of a simple word value depicting how the rearrangement of Hebrew letters within a first Hebrew word may yield a Hebrew anagram word having the same word value.

FIG. 7A is a visual depiction of the Hebrew alphabet highlighting the position of Hebrew letters within the Hebrew alphabet to yield a Hebrew word along with its English equivalent and its Hebrew equivalent in the English language.

FIG. 7B is a sixth example of a simple word value equation by which the Hebrew word for “truth” is subtracted from the Hebrew word for “lie” to yield a difference word value of 159 corresponding to the Hebrew word for “small”.

FIG. 8A is a visual depiction of a dominant word value within the Hebrew language, namely 37, along with a Hebrew word corresponding to the dominant word value, its English equivalent, and its Hebrew equivalent in the English language.

FIG. 8B is a visual depiction of the dominant word value otherwise depicted in FIG. 8A overlaid upon imagery of a human torso corresponding to normalized human body temperature in degrees Celsius.

FIG. 9A is a visual depiction of summing the initial letter values for each of seven Hebrew words and dividing the resulting word value by the number of initial letter values to yield an average value of 3.14 or T.

FIG. 9B is a visual depiction of a sentence value determination as derived from a first verse of the original Hebrew bible string that is equivalent to the first 611 post decimal digits of FIG. 10 is a visual depiction of how initial letters of biblical names in Hebrew together form the Hebrew word for Israel.

FIG. 11A is a first depiction of the Star of David shown comprising an inner and an outer hexagram, the inner hexagram comprising 37 dots and the outer hexagram comprising 36 dots.

FIG. 11B is a second depiction of the Star of David shown comprising an inner hexagon and a series of six radiating triangles, the inner hexagon comprising 37 dots and the series of six radiating triangles comprising a total of 36 dots.

FIG. 12 is a visual depiction of the various Hebrew letters overlaid upon portions of the Star of David.

FIG. 13 is a visual depiction of the sonic hedgehog protein with Hebrew lettering and corresponding code2GOD value demonstrating overlap with other words and phrases having the same code2GOD value.

FIG. 14 is a visual depiction in support of a utilitarian aspect of a code2GOD divine decoder tool according to the presently disclosed subject matter demonstrating various value connections associated with the term YHWH.

FIG. 15 is a second visual depiction in support of a utilitarian aspect of the code2GOD divine decoder tool demonstrating various value connections associated with the term YESHUA.

FIG. 16 is a first visual depiction in support of a utilitarian aspect of the code2GOD divine decoder tool demonstrating last-to-first continuity of word sequences.

FIG. 17 is a second visual depiction in support of a utilitarian aspect of the code2GOD divine decoder tool demonstrating last-to-first continuity of word sequences.

FIG. 18 is a visual depiction in support of a utilitarian aspect of the code2GOD divine decoder tool directed to understanding the creation of life and the universe.

FIG. 19 is a screenshot of a graphical user interface of the code2GOD divine decoder tool according to the presently disclosed subject matter before the user inputs Hebrew words for analysis.

FIG. 20 is a screenshot of the graphical user interface of the code2GOD divine decoder tool according to the presently disclosed subject matter after the user has input exemplary Hebrew words for analysis.

FIG. 21 is an enlarged fragmentary sectional view of the graphical user interface otherwise depicted in FIG. 19 enlarged to show in greater detail the upper left portion thereof having a Hebrew word input portion.

FIG. 21A is an enlarged fragmentary sectional view of the upper left portion of the graphical user interface enlarged to show in greater detail output details associated with a reference Hebrew word and a comparison Hebrew word input at the Hebrew word input portion.

FIG. 21B is an enlarged fragmentary sectional view of the upper left portion of the graphical user interface enlarged to show in greater detail output details associated with a reference Hebrew phrase input at the Hebrew word input portion.

FIG. 22 is an enlarged fragmentary sectional view of the upper right portion of the graphical user interface enlarged to show in greater detail output details associated with a Pi calculation portion before analyzing a reference Hebrew word or a reference Hebrew phrase.

FIG. 22A is a depict of the upper portion of the graphical user interface showing the Hebrew word input portion and the Pi calculation portion or tool according to the presently disclosed subject matter showing details associated with the reference Hebrew word input at the Hebrew word input portion.

FIG. 22A is a depiction of the upper portion of the graphical user interface showing the Hebrew word input portion and the Pi calculation portion or tool according to the presently disclosed subject matter showing details associated with the reference Hebrew word input at the Hebrew word input portion.

FIG. 22B is a depiction of the upper portion of the graphical user interface showing the Pi calculation portion or tool according to the presently disclosed subject matter showing a code2GOD value input for analysis and showing a number location of the code2GOD value within a portion of the Pi string.

FIG. 23 is a depiction of a lower portion of the graphical user interface of the code2GOD divine decoder tool according to the presently disclosed subject matter showing a research results compilation with a highlighted portion summarizing Hebrew terms having a primary word value of 86.

FIG. 23A is an enlarged depiction of the highlighted portion otherwise shown in FIG. 23 enlarged to show in greater detail the Hebrew terms having a primary word value of 86.

FIG. 23B is a depiction of a code2GOD hopping feature or tool of the code2GOD divine decoder tool according to the presently disclosed subject matter.

FIG. 23C is a depiction of a code2GOD before/after feature or tool of the code2GOD divine decoder tool according to the presently disclosed subject matter showing a first example of a Hebrew word analysis.

FIG. 23D is a depiction of a code2GOD before/after feature or tool of the code2GOD divine decoder tool according to the presently disclosed subject matter showing a first example of a Hebrew word analysis.

FIG. 24 is a value table setting forth rows and columns of the Hebrew alphabet setting forth Hebrew letters, letter values for each Hebrew letter, minimal letter number values for each Hebrew letter, first extended number values for each Hebrew letter and second extended number values for each Hebrew letter.

### DETAILED DESCRIPTION OF THE EMBODIMENTS

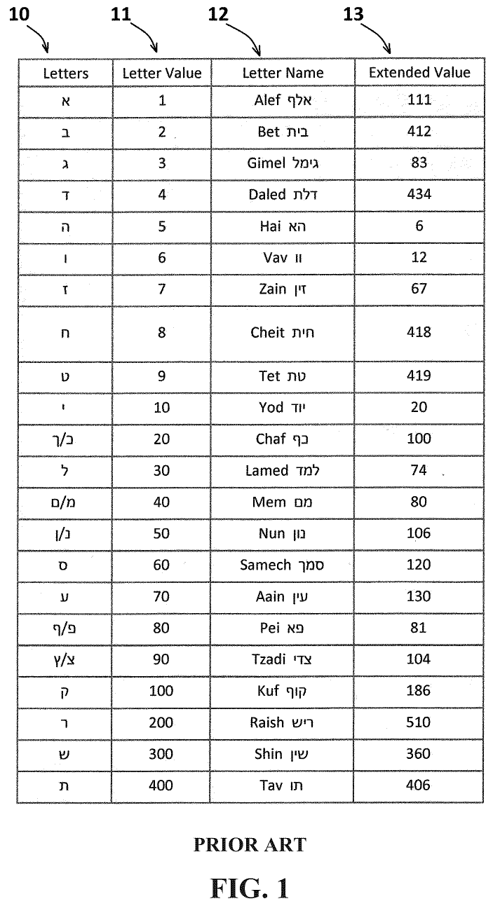

Referring now to the drawings with more specificity, the following specifications generally describe a system and method for deriving secondary or code2GOD meaning from scripture as exemplified by an Original Bible-coded letter string comprising a single continuous string of 1,197,000 Hebrew letters devoid of spaces and punctuation. These specifications describe a number of codes or algorithms for deciphering or deriving secondary or code2GOD meaning from Hebrew scripture as exemplified by the original Hebrew bible letter string noting that each Hebrew letter or character of the Hebrew alphabet has an inherent value associated therewith. In this regard, the reader is firstly directed to FIG. 1 detailing or listing (a) the twenty-two Hebrew letters as set forth in Column 10; (b) the numerical letter values associated with each Hebrew letter or character as set forth in Column 11; (c) the letter name or nomenclature for each Hebrew letter written in both English and corresponding Hebrew as set forth in Column 12; and (d) extended word values for the Hebrew letter names as set forth in Column 13.

Referencing FIG. 1, the reader will note that Each of the biblical Hebrew letters set forth in Column 10 comprises or is associated with a numerical letter value (letter=value) as further set forth in corresponding rows in Column 11. While an English letter is only a pronounced symbol, each of the biblical Hebrew letters further corresponds or is associated with a personal name comprising a plurality of Hebrew numerical value-based letters. For ease of understanding both English and Hebrew names of each Hebrew letter are presented or set forth in Column 12. The name or nomenclature of each Hebrew letter has a numerical value called an “extended value” as set forth in Column 13. A first code or algorithm or Code No. 1 upon which the present invention builds is a biblical numerical letter value of each Hebrew letter. These numerical letter values are set forth in Column 11. A second code or algorithm or Code No. 2 upon which the present invention builds is the extended word value of each Hebrew letter name set forth in Column 12. These extended word values are set forth in Column 13.

For example, in a first instance, the biblical Hebrew letter “ [symbol] ” has a numerical letter value of 1 and is pronounced like the letter, “A” in the English language. The name or nomenclature for the biblical Hebrew letter, “ [symbol] ” is “Alef” in the English language or, “ [symbol] ” in the Hebrew language with an extended word value of 111 as calculated by summing the numerical letter values for each Hebrew letter within the letter name. From left to right for ease of understanding, the Hebrew letter, “ [symbol] ” is associated with the numerical letter value 80, the Hebrew letter, “ [symbol] ” is associated with the numerical letter value 30; and the Hebrew letter, “ [symbol] ” is associated with the numerical letter value 1.

These numerical letter values sum to a word value (20) of 111 and this total is the extended word value for the named Hebrew letter, “ [symbol] ”. For example, in a second instance, the biblical Hebrew letter, “ [symbol] ” letter value is 100, pronounced like, “K” in the English language. Its English name is, “Kuf” and its Hebrew name is, “ [symbol] ” with an extended word value of 186. From left to right for ease of understanding, the Hebrew letter, “ [symbol] ” is associated with the numerical letter value 80, the Hebrew letter, “ [symbol] ” is associated with the numerical letter value 6; and the Hebrew letter, “ [symbol] ” is associated with the numerical letter value 100. These numerical letter values sum to 186 and this total is the extended word value for the named Hebrew letter, “ [symbol] ”.

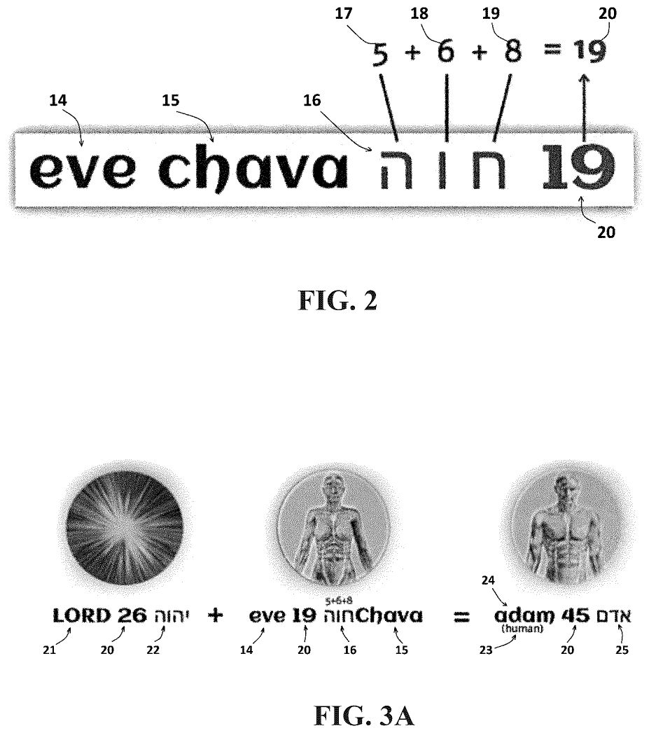

A third code or algorithm or Code No. 3 upon which the present invention builds is a word value (20) associated with a Hebrew word. In this regard, a Hebrew word comprises a series of Hebrew letters and the numerical letter values of each Hebrew letter within the Hebrew word are added to provide the word value (20). In this regard, the reader is directed to FIG. 2, which figure provides an example of how a word value (20) is calculated for the exemplary English word, “Eve” as at (14) otherwise pronounced as “Chava” as at (15) in Hebrew and written as, “ [symbol] ” as at (16) in Hebrew. From left to right for ease of understanding, the Hebrew letter, “ [symbol] ” is associated with the numerical letter value 5 as at (17); the Hebrew letter, “ [symbol] ” is associated with the numerical letter value 6 as at (18); and the Hebrew letter, “ [symbol] ” is associated with the numerical letter value 8 as at (19). These numerical letter values sum to 19 and this total is the extended word value (20) for the Hebrew word, “ [symbol] ” (16).

Word values (20) may essentially be used anagrammatically or in equations to yield code2GOD messaging or secondary meaning as derived from the primary meaning of the words within the original Hebrew biblical letter string. Secondary or code2GOD meaning derived from the original Hebrew biblical letter string may relate to how the human environment is structured and how humans are wired for a meaningful life within that human environment. These code2GOD messages or the secondary meaning associated therewith may be regarded as scientific, social, and meant to improve the wellbeing of humanity. This secondary or code2GOD meaning can help bolster one's appreciation and understanding of environmental structure and the role humans play in that environmental structure.

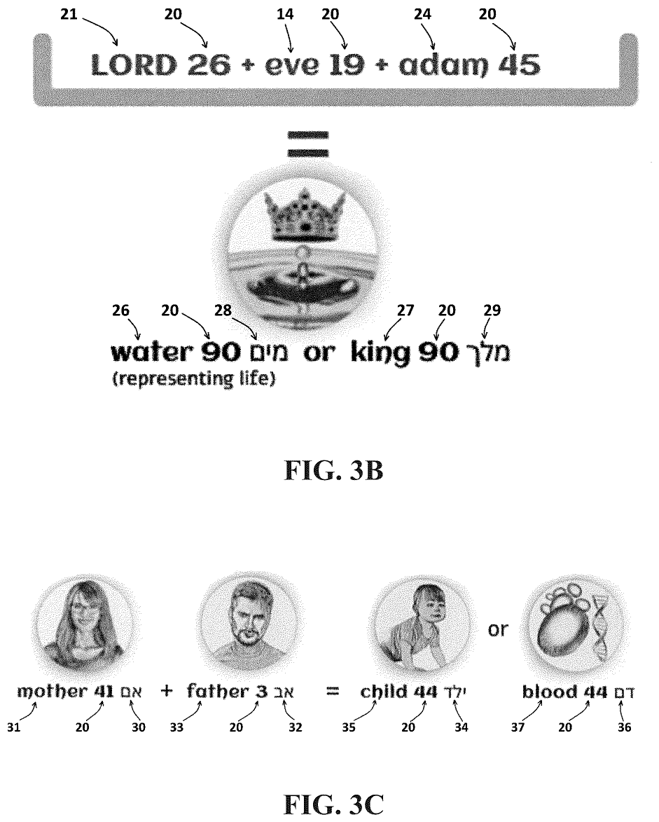

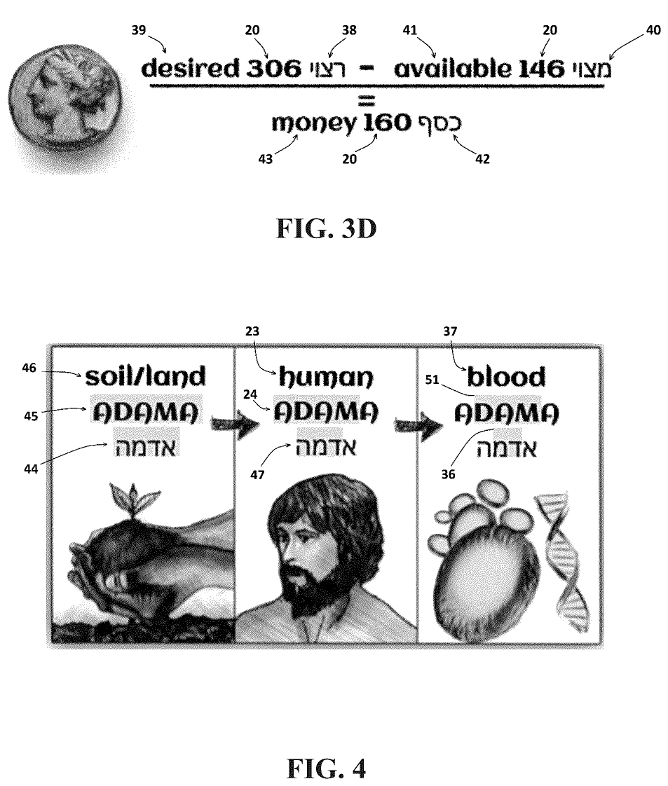

A fourth code or algorithm or Code No. 4 according to the present invention is the use of Hebrew words as meaningful equations, and is illustrated by the following examples as further supported by FIGS. 3A-6. A first example of the use of Hebrew words as equations or Code No. 4 according to the present invention is generally illustrated in FIG. 3A in the form of a first simple addition operation. Referencing FIG. 3A, the reader will there first consider the English word, “Lord” as at (21) otherwise written as, “ [symbol] ” in Hebrew as at (22). The word value (20) for, “Lord” (21) or, “ [symbol] ”) is 26 in Hebrew. The reader will further recall the word value (20) for the English word, “Eve” (14) or “Chava” (15) or “ [symbol] ” (16) in Hebrew is 19. Summing the word values (20)) of 26 for, “Lord” (21) or “ [symbol] ”) and 19 for “Eve” (14) or “Chava” (15) or “ [symbol] ” (16) equals or provides a word value (20) of 45. The word value (20) of 45 equates with the word value (20) of the Hebrew word, “ [symbol] ” as at (25) otherwise written in English as “human” as at (23) or “Adam” as at (24).

Referencing FIG. 3B, the reader will there consider a second example of the use of Hebrew words as equations or Code No. 4 according to the present invention in the form of a second simple addition operation. Recalling the word value (20) for the Hebrew word or term, “ [symbol] ” (22) (or in English, “Lord” (21)) equals 26 and that the word value (20) for “Chava” (15) or “ [symbol] ” (16) in Hebrew (or in English, “Eve” (14)) is 19 the decoder can then add the Hebrew word, “ [symbol] ”) with a word value (20) of 19. The total resulting word value (20) is 90, which corresponds to the word value (20) for either, “ [symbol] ”) or “ [symbol] ”) in Hebrew which translate to “water” (26) (representing life) or “king” (27) in English, respectively.

Referencing FIG. 3C, the reader will there consider a third example of the use of Hebrew words within simple word-based equations or Code No. 4 according to the present invention in the form of a third simple addition operation. The word value (20) for the Hebrew term, “ [symbol] ” (22) (or in English, “mother” (31)) equals 41 and the word value (20) for the Hebrew term, “ [symbol] ” (32) (or in English, “ ” father” (33)) equals 3. Adding the word values (20) of “ [symbol] ” or 41 and “ [symbol] ” or 3 equals a word value (20) of 44, which word value (20) corresponds to either the Hebrew term, “ [symbol] ” or in English, “child” (35), or the Hebrew term, “ [symbol] ”) or in English, “blood” (37). When interpreted by a chosen interpreter, the resulting secondary or code2GOD meaning may translate into a message that a “mother” (31) and a “father” (33) together yield a “child” (35) or alternatively, “blood” line (37).

Referencing FIG. 3D, the reader will there consider a fourth example of the use of Hebrew words as equations or Code No. 4 according to the present invention in the form of a simple subtraction operation. The word value (20) for the Hebrew term, “ [symbol] ”) (or in English, “desired” (39)) equals 306 and that the word value (20) for the Hebrew term “ [symbol] ”, (40) (or in English, “available” (441)) equals 146. Subtracting the word value (20) of the Hebrew “ [symbol] ” (40) or 146 from the Hebrew “ [symbol] ” (38) or 306 equals a word value (20) of 160, which word value (20) corresponds to the Hebrew term, “ [symbol] ” (42) (or in English, “money” (43)). When interpreted by a chosen interpreter, the resulting secondary or code2GOD meaning may translate into a message that “money” (43) can close the gap between the “desired” (39) and the “available” (41). A fifth non-illustrated example of the use of Hebrew words as equations or Code No. 4 according to the present invention in the form of a second simple subtraction operation, as follows: Male=227=zachar=“ [symbol] ”=minus Female=157=nekeva “ [symbol] ”=Confusion=70=bilbul=“ [symbol] ”.

Referencing FIG. 4, the reader will there consider a first example of a fifth code or algorithm or Code No. 5 according to the present invention. Code No. 5 is essentially the telling of a story in a single Hebrew word. The Hebrew letters that make up the Hebrew word can be reassembled in a different order or broken into sub-words to create a message or a story, while maintaining the same overall word value. For example, the Hebrew word, “ [symbol] ” (44) or in English “Adama” (45) (meaning land/soil (46)) having a word value (20) of 50 comprises the Hebrew word, “ [symbol] ”) or in English Adam (24) meaning “human” (23) having a word value (20) of 49, which Hebrew word, “ [symbol] ”) further comprises the Hebrew word, “ [symbol] ” (36) or in English “dam” (51) meaning blood (37) with a word value (20) of 44. The resulting secondary or code2GOD meaning may translate into a message that humans have a soul-blood bond with the land or that humans were originated from and shall return to buried in/become soil.

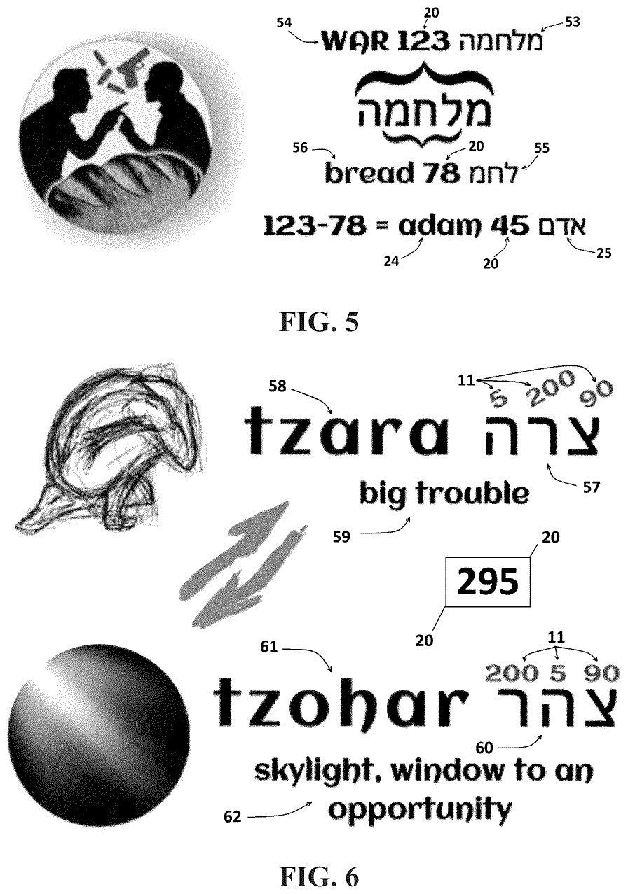

Referencing FIG. 5, the reader will there further consider a second example of Code No. 5 according to the present invention. The Hebrew word, “ [symbol] ” (53) or in English “war” (54) having a word value (20) of 123 comprises the Hebrew word, “ [symbol] ” (55) or in English “bread” (56) having a word value (20) of 78. The word value (20) of 123 for “war” (54) less the word value (20) of 78 for “bread” (56) yields a word value (20) of 45, which word value (20) 45 corresponds to or equates with the word value (20) of the Hebrew word, “ [symbol] ” (25) otherwise written in English as “human” (23) or “Adam” (24). The resulting secondary or code2GOD meaning may translate into a message that humans were created to always fight for their bread or existence.

Third and fourth examples of Code No. 5 not specifically illustrated include the following: the Hebrew word, “ [symbol] ” or “kelev” meaning “dog” in English has a word value (20) of 52. By subtracting, “ [symbol] ” with word value (20) of 20 from, “ [symbol] ” with word value (20) of 52, the result is, “ [symbol] ” with word value (20) of 32 with English translation, “like a heart”. Further, the six Hebrew letters that together form the first Hebrew word of the Original Bible are “ [symbol] ” or “bereshit” meaning “Genesis” in English and has a combined word value (20) of 913. These individual Hebrew letters can be rearranged into at least twenty-two separate Hebrew words, each with a related meaning to the concept of creation. The Chosen interpreter may then utilize these twenty-two anagram words to better elaborate upon or otherwise explain secondary or code2GOD meaning relating to the formation of the universe.

A sixth code or algorithm or Code No. 6 according to the present invention relates to Hebrew words having identical word values (20). In other words, different Hebrew words that share the same word value (20) can also be interpreted to share other attributes in common for revealing secondary or code2GOD meaning as exemplified by the concepts of love, money, family, soul, life purpose, etc. For example, a word value (20) of 13 may be equated with the and lost or; “ [symbol] ” worry or; “ [symbol] ” fairytale or; “ [symbol] ” one or; “ [symbol] ” following: love or “ [symbol] ”. A word value (20) of 160 may be associated with money or “ [symbol] ”; tree or; “ [symbol] ” codes or; “ [symbol] ” and tone or “ [symbol] ”. A word value of 395 may be equated with higher soul or “ [symbol] ”; and the skies or “ [symbol] ”. A word value of 90 may be associated with water or “ [symbol] ” and newborn or “ [symbol] ” A word value of 160 may be equated with tree or “etz” or “ [symbol] ” money or “kesef” or “ [symbol] ”=codes or “kodim” or “ [symbol] ”. The resulting secondary or code2GOD meaning may translate into a message that having the right codes (like formula) can help one grow more greens (money) and branches.

A seventh code or algorithm or Code No. 7 according to the present invention involves the provision of parable messaging via anagram. In other words, the rearrangement of Hebrew letters (each having a numerical letter value (11)) within a Hebrew word yields a different secondary or code2GOD meaning while maintaining the same numerical word value (20).

Referencing FIG. 6, the reader will there consider the Hebrew word, “ [symbol] ” (57) or “tzara” (58) or in English “big trouble” (59). This Hebrew word has a word value (20) of 295. The anagram “ [symbol] ” (60) or “tzohar” (61) or in English “skylight or window to an opportunity” (62) comprises the same word value (20) of 295.

The resulting secondary or code2GOD meaning may translate into a message that trouble (with an inherent negative connotation) may provide a window to an opportunity (with an inherent positive connotation). In other words, when encountering “big trouble” (59) or “ [symbol] ” (57) or “tzara” (58), look for the “bright opportunity” (62) or “ [symbol] ” (60) or “tzohar” (61). Conversely, when encountering “ [symbol] ” (60) or “tzohar” (61) or an “opportunity” (62), be careful to avoid “ [symbol] ” (57) or “tzara” (58) or “big trouble” (59). Other non-illustrated examples include a word value (20) of 78 which equates with either “ [symbol] ” or in English “bread” or “ [symbol] ” or in English “salt”; and the word value (20) of “ [symbol] ” or “yekum” or in English universe or “ [symbol] ” or “ki-iom” or in English “survival”.

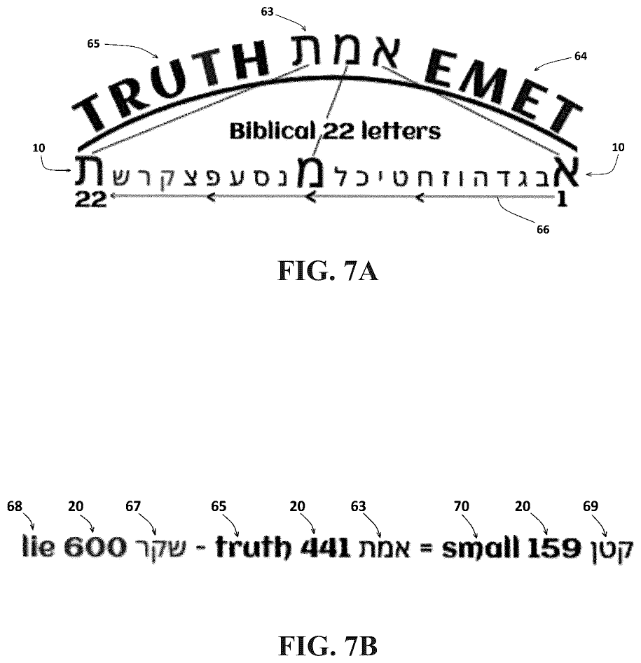

An eighth code or algorithm or Code No. 8 according to the present invention involves the position of the respective Hebrew letters within the table otherwise presented in FIG. 1. In other words, observing the letters' relative (or absolute) position on the lineup from the first Hebrew letter, “ [symbol] ” to the last Hebrew letter, “ [symbol] ”, can be seen to reveal secondary or code2GOD meaning. In this regard, the reader is directed to FIG. 7. Referencing FIG. 7, the reader will there consider the Hebrew word, “ [symbol] ” (63) or “emet” (64) or in English, “truth” (65). The Hebrew word, “ [symbol] ” (63) comprises the first Hebrew letter, “ [symbol] ” with a numerical letter value of 1; the last Hebrew letter, “ [symbol] ” with a numerical letter value of 400; and a middle Hebrew letter, “ [symbol] ” with a numerical letter value (11) of 40 combining to provide a total word value (20) of 441. The resulting secondary or code2GOD meaning may translate into a message that “truth” (65) is not definite and can be found within the entire spectrum of possibilities as at (66).

Comparatively referencing FIGS. 7A and 7B, the reader will further consider the Hebrew word, “ [symbol] ” (67) or “sheker” or in English, “lie” (68). The Hebrew word, “ [symbol] ” (67) comprises the 19^{th}, 20^{th}, and 21^{st} Hebrew letters ahead of the last Hebrew letter, “ [symbol] ”. Noting that the last or 22^{nd} Hebrew letter, “ [symbol] ” is found within the Hebrew word, “ [symbol] ” (63) for “truth”, a secondary or code2GOD meaning that may be derived from the Hebrew word, “ [symbol] ” (67) is that humans are wired to know, or identify, what a “lie” (68) is, which is also intentional, according to Code No. 8. However, even a “lie” (68) is set within a slim possibility of being within the spectrum of the truth. Furthermore, humans should not shrink from truth telling and for the decoder/student to be open to receiving the truth on the entire spectrum of life's possibilities. Recalling Code No. 4, (Words As Meaningful Equations) the reader will further see that the difference between a “lie” (68) with a word value (20) of 600 and the “truth” (65) with a word value (20) of 441 can be “small” (70) or in Hebrew, “ [symbol] ” which Hebrew term equates to a total word value (20) of 159.

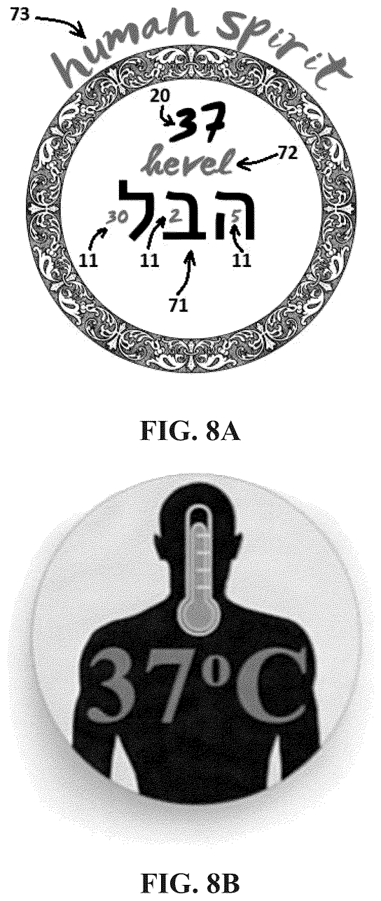

A ninth code or algorithm or Code No. 9 according to the present invention involves the identification of a mystery, dominant, meaningful, or repetitive number within the numerical word values (20) provided by the Hebrew language. In this regard, the chosen interpreter will cross reference word values (20) with facts of life to provide code2GOD messaging or secondary meaning as derived from these mystery, dominant, meaningful, or repetitive number values inherent to the Hebrew language. FIGS. 8A through 8C are presented in support of Code No. 9. Referencing FIG. 8A, the reader will there consider the first verse of the original Hebrew bible comprises a word value (20) sum of 2701 as derived from the addition of all 28 letters of this first verse.

An example of a mystery, dominant, meaningful, or repetitive number within the numerical word values (20) provided by the Hebrew language is the number 37. The reader will note that the number 2701 as derived by the addition of all 28 Hebrew letters of the first verse of the original Hebrew bible is also the product of the numerical value 37 multiplied by the numerical value 73. The number 2701 is also the sum of 37+999+888+777. The number 37 is also a multiplier of 999 (i.e. 37×27), of 888 (i.e. 37×24) and of 777 (i.e. 37×21). According to the present invention, the chosen interpreter may derive the importance of the number 37 and relate to this to the human condition as derived from within the Hebrew language. The number 37, for example, is the human body temperature (and also the body temperature of certain mammals: whale (sea), bat (air) and lion (ground)) in Celsius degrees as generally depicted in FIG. 8B, and may thus be translated as evidencing the “human spirit” (73) as comparatively referenced in FIG. 8A. Referencing FIG. 8A, the reader will there consider the word value (20) of the Hebrew word, “ [symbol] ” (71) or “Hevel” (72) comprising the first Hebrew letter, “ [symbol] ” and the last Hebrew letter, “ [symbol] ” of the Torah and the Original Bible and in English is “Habel” (Hevel or [symbol] ) representing the “human spirit” (73).

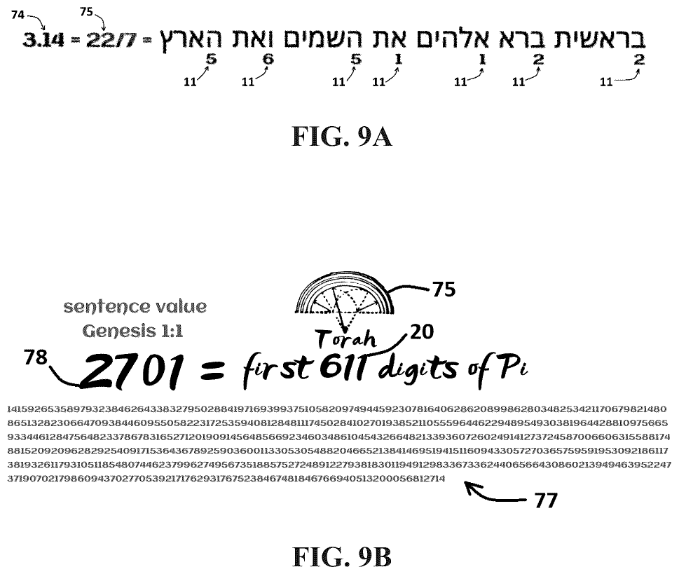

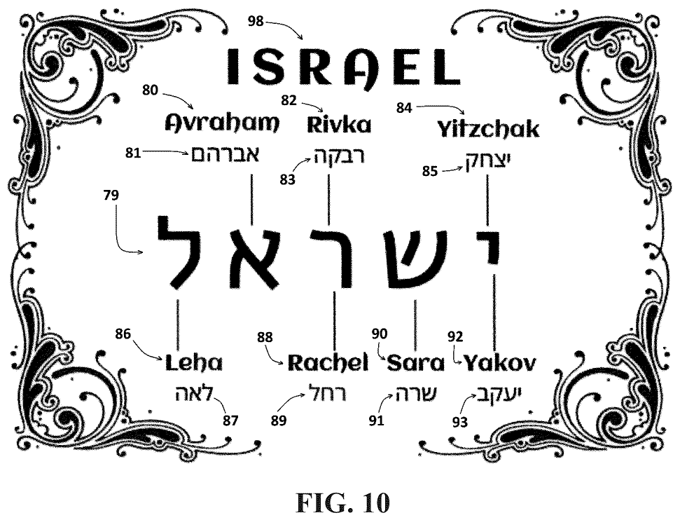

A tenth code or algorithm or Code No. 10 according to the present invention involves the use of Pi or in Greek, “π”. It is noted that the numerical value of Pi (the ratio of a circle's circumference to its diameter) is commonly understood to comprise an infinite number of digits after the primary integer value of 3 as in 3.14159 . . . . The concept of Pi or “71” is encoded in the first verse of the Original Bible in the Hebrew language. In this regard, it is noted that the value of 3.14 (74) is the average letter value of each of the first letters of each of the seven words of the first verse of the Original Bible in Hebrew. In this regard, the reader is directed to FIG. 9A. Referencing FIG. 9A, the reader will there consider the first seven Hebrew words of the first verse with numerical letter values (11) presented for each of the first seven Hebrew words. Summing these numerical letter values provides a sum of 22 as at (75), which when divided by the number of Hebrew words or 7 yields 3.14 (74). This so-called Pi decoder or π decoder feature aids in deriving secondary or code2GOD meaning or verifying previous findings. Code No. 9 according to the present invention utilizes four Pi/π parameters, namely, (1) the sum of a set string of numbers; (2) the number of digits in a set string; (3) the starting digit number in the Pi/π infinite string; and (4) adjacent coded set of numbers.

For example, referencing FIG. 9B, the reader will there consider a representation of the first 5 books of the Bible commonly referred to as the Torah as at (76) or in Hebrew, “ [symbol] ” with a word value (20) of 611. The first 611 post decimal digits as at (77) of Pi/π sum to the numerical value of 2701 as at (78), which numerical value 2701 (78) is exactly the verse value of biblical Genesis 1:1 describing the concept of creation. The resulting secondary or code2GOD meaning may translate into a message that the world was created based on the Torah (76) of the Bible, and that the Pi/π code of Code No. 9 may help function as a cross-reference and/or confirmation of the primary meaning otherwise derived from the face value of the first verse and the Hebrew word, “ [symbol] ”.

An eleventh code or algorithm or Code No. 11 according to the present invention involves the use of acronyms to form word values (20) for the purpose of deriving secondary or code2GOD meaning from the Hebrew words from which initial Hebrew letters are lifted to form the acronym. In this regard, it is noted that an acronym is an abbreviation formed from the initial letters of other words and pronounced as a word. Referencing FIG. 10, the reader will there consider the first Hebrew letter of each of three fore fathers' and the four fore mothers' names make up the acronym name, “Israel” (98) or in Hebrew, “ [symbol] ” (79). The three fore fathers' names are “Avraham” (80) or in Hebrew, “ [symbol] ” (81); “Rivka” (82) or in Hebrew, “ [symbol] ” (83), and “Yitzchak” (84) or in Hebrew, “ [symbol] ” (85). The four fore mothers' names are “Leha” (86) or in Hebrew, “ [symbol] ” (87); “Rachel” (88) or in Hebrew, “ [symbol] ” (89); “Sara” (90) or in Hebrew, “ [symbol] ” (91); and “Yakov” (92) or in Hebrew, “ [symbol] ” (93). A secondary or code2GOD meaning derived from the acronym name, “Israel” (98) or in Hebrew, “ [symbol] ” (79) is that the for elders are inherently tied to the state or concept of Israel.

A twelfth code or algorithm or Code No. 12 according to the present invention involves the use of natural logarithm to derive secondary or code2GOD meaning from word values (20). The natural logarithm of a number is its logarithm to the base of the mathematical constant e, which is an irrational and transcendental number approximately equal to 2.718281828459. Code No. 12 is used to calculate the scientific correlation of spatial information such as distances (e.g. the distance from the Earth to the sun); temporal information such as periods of time; and other perceptive information including audible information (e.g. sounds), visual information (e.g. colors), frequency information, etc.

A thirteenth code or algorithm or Code No. 13 according to the present invention involves the use of simplified numerology. Given a word value (20), the single digits of the word value (20) may be summed to arrive a final reduced number between 1 and 9. If the finally reduced number is 11, 22, 33, or 44, these numbers will not be reduced any further for they are considered unique numbers. For example, a word value (20) of 728 is firstly reduced to 17 by adding 7, 2, and 8 or 7+2+8=17, and then secondly reducing 17 or 1+7=8. The word value (20) of 911 finally reduces to 11 and not 2 since 11 is one of the four unique numbers.

Recalling the mystery, dominant, meaningful, or repetitive number 37 (e.g. body temperature is 37° C.), it will be seen the number firstly reduces to 10 (perfection) and secondly reduces to 1. A secondary or code2GOD meaning that may be derived from the number 37 is that the firstly reduced number 10 may mean, “perfection” and the secondly reduced number of 1 may mean, “new beginnings or the concept of divinity”. A further example is illustrated by the simple numerology or finally reduced number that can be used to show that various words having the same finally reduced number have something in common. For example, the word, “lung” or in Hebrew, “ [symbol] ” has a word value (20) of 180; the word, “nose” or in Hebrew, “ [symbol] ” has a word value (20) of 81; the word, “nature” or in Hebrew “ [symbol] ” has a word value (20) of 81; the word, “face” or in Hebrew, “ [symbol] ” has a word value (20) of 180; and the word, “eyes” or in Hebrew, “ [symbol] ” has a word value of 180. All of these word values (20) finally reduce to the number 9 and all the words have anatomical connotations in common.

A fourteenth code or algorithm or Code No. 14 according to the present invention involves interval skipping within a string of Hebrew letters. There are three factors to consider when finding a Hebrew word within a string of Hebrew letters as exemplified by the Original Bible character string comprising 1,197,000 Hebrew letters. These three factors include (1) the starting or initial Hebrew letter in the string, (2) the number of Hebrew letters to skip over, and (3) directional movement within the string (i.e. forward or backward). The reader will here consider the Hebrew word, “ [symbol] ” or “malachim” or in English, “Angels” having a word value (20) of 141. This word can be derived from biblical Genesis 1:8 as at (94) starting with the initial letter number 663 and interval skipping in a backward direction a total of 6 letters until the Hebrew word, “ [symbol] ” is finally formed.

Note that the word value (20) of 141 finally reduced to simple numerology is 6 which is the number of interval skipped letters in this example. It is estimated that 0.1% of human DNA is unique to every human, which translates into roughly 32 million repetitions of the compounds Adenine (A), Cytosine (C), Guanine (G) and Thymine (T). The original Hebrew Bible string comprises 1,197,000 Hebrew letters of which there are 22 in the Hebrew alphabet or Alef-Beit. It is noted that locating genetic traits within human DNA is similar to finding meaningful words and events within the original Hebrew Biblical string and given the complexity of such sequences may be preferably performed by a computer.

A fifteenth code or algorithm or Code No. 15 according to the present invention follows from the observation that a set of Hebrew words can be correlated for deriving secondary or code2GOD meaning therefrom by way of applying mathematical operations to a given Hebrew word and its corresponding word value (20). For example, multiplications of the word, “lord” (21) or in Hebrew, “ [symbol] ” or “yhvh” (22) having a word value (20) of 26 may yield word value (20) multiples of 26 and provide the chosen interpreter with information relating to the given word.

A further example is illustrated by the Hebrew word, “ [symbol] ” (81) or “Avraham” (80) or in English, “Abraham” having a word value (20) of 248. The Hebrew word, “ [symbol] ” or in English, “eden” has a word value (20) of 124 and multiplied by 2 equates to 248 as in 124×2=248. Eden may thus correlate with Abraham via a multiplier of 2 and this information can be used to derive secondary or code2GOD meaning from the words illustrated. Further, the Hebrew names, “ [symbol] ” or “Yitzchak” or in English, “Isaac”; “ [symbol] ” or “Yakov” or in English, “Jacob”; and “ [symbol] ” or “Yosef” or in English, “Josef” have corresponding word values (20) of 208=26×8; 182=26×7; and 156=26×6, respectively. The common multiplier of 26 is found in each word value (20) for these Hebrew names and this information can be used by the chosen interpreter to derive secondary or code2GOD meaning from the Hebrew names.

Recalling the Original Bible's first verse sum of all 28 letters is 2701 as at (78), the reader will note that this number is the product of the dominant, meaningful, or repetitive number 37 multiplied by 73 as in 2701=37×73. The number 2701 (78) is also the sum of 37+999+888+777. The dominant, meaningful, or repetitive number 37number 37 is also a factor of 999 (as in 999=37×27), of 888 (as in 888=37×24), and 777 (as in 777=37×21). A secondary or code2GOD meaning that can be derived from the numbers 2701 and 37. As previously described, 37 degrees Celsius is the average human body temperature and that of certain mammals including whales (with sea habitat), bats (with air habitat) and lions (with ground habitat). The number 37 is also the word value (20) of “Hevel” or “ [symbol] ” comprising the first letter ( [symbol] ) and the last letter ( [symbol] ) of the Torah (75) and the Original Bible. The number 37 is also the word value (20) corresponding to the Hebrew, “ [symbol] ” (71) or “Hevel” (72) or in English, Abel representing the human spirit (73).

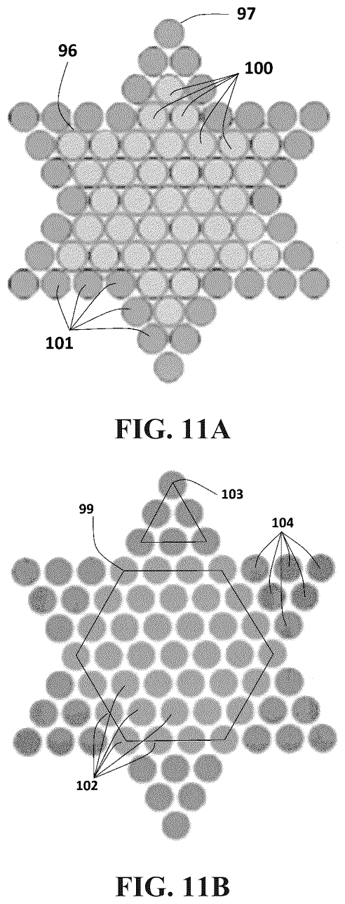

A sixteenth code or algorithm or Code No. 16 according to the present invention involves the use of geometrical shapes from which to derive secondary or code2GOD meaning. The Star of David Theorem is a mathematical result on arithmetic properties of binomial coefficients. Comparatively referencing FIGS. 11A and 11B it will there be seen that the numbers 37 and 73 are inherently represented by the Star of David theorem. FIG. 11A comprises an inner hexagram as at (96) comprising 37 points (100) shown in first or relatively light grayscale coloration peripherally bound an outer hexagram as at (97) comprising 36 points (101) shown in second or relatively dark grayscale coloration together summing to a total of 73 points.

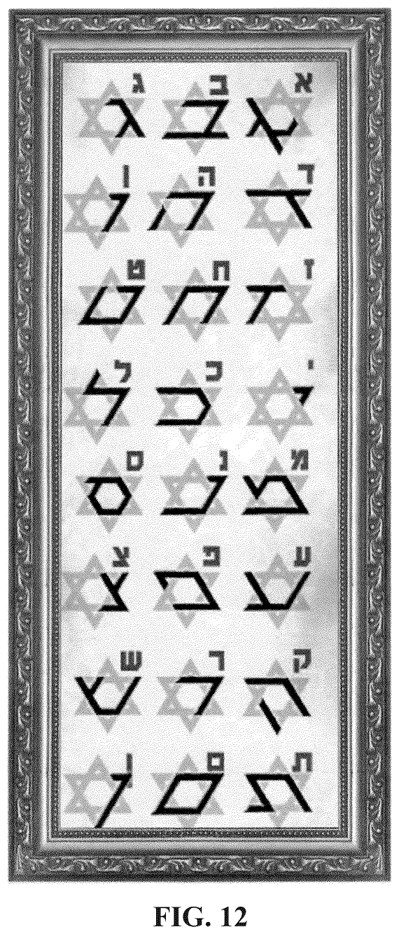

FIG. 11B by contrast comprises an inner hexagon (99) comprising 37 points (102) with 6 peripheral triangles (103) each of which comprise 6 points (104) summing to a total of 73 points. As previously described, the number 2701 (78) is the product of 37 and 73 as found within the original Hebrew bible string. The Star of David may also comprise a total of 541 points which equates with the word value (20) for the Hebrew, “ [symbol] ” (79) or in English, “Israel” (98). Referencing FIG. 12C it will be seen that the Hebrew letter character forms of which there are 24=22+2 all correspond to portions of the Star of David. It will thus be seen that geometrical shape information can also be used to convey secondary or code2GOD meaning as derived from original Hebrew scripture.

A seventeenth code or algorithm or Code No. 17 according to the present invention involves counting the number of letters in a word, related words, or a sentence. For example, there are 13 Hebrew letters in the four names of the fore mothers: “Leha” (86) or in Hebrew, “ [symbol] ” (87); “Rachel” (88) or in Hebrew, “ [symbol] ” (89); “Sara” (90) or in Hebrew, “ [symbol] ” (91); and “Yakov” (92) or in Hebrew, “ [symbol] ” (93). Further, there are 13 Hebrew letters in the three names of the fore fathers: “Avraham” (80) or in Hebrew, “ [symbol] ” (81); “Rivka” (82) or in Hebrew, “ [symbol] ” (83), and “Yitzchak” (84) or in Hebrew, “ [symbol] ” (85). The number 13 is the word value (20) for the Hebrew word, “ [symbol] ” or in English, “love”. Adding the number 13 to 13 yields 26, which is the word value (20) for the Hebrew word, “ [symbol] ” (22) or in English, “Lord” (21). These numerical results point to specific verse numbers between 1 and 23,204.

Similarly, the number of singular word repetitions in the original Hebrew Bible string can provide meaningful word values (20). Further, matching the first and last letters of a Hebrew word with the first and last letters of a verse from the original Hebrew bible string provides information for deriving additional secondary or code2GOD meaning. Further, matching name word value (20) with verse value or consecutive word value provides information for deriving additional secondary or code2GOD meaning. Further, using prime numbers to explain correlations between Hebrew words or verses provides information for deriving additional secondary or code2GOD meaning. Still further, using sequential Fibonacci numbers as reference for related Hebrew words provides information for deriving additional secondary or code2GOD meaning.

An eighteenth code or algorithm or Code No. 18 according to the present invention involves observation of various characteristics of each Hebrew letter to derive secondary or code2GOD meaning. In this regard, it is noted that each Hebrew letter or character form comprises a particular form, a name, and a name value. In this regard, the particular form of Hebrew letters can be analyzed for providing secondary or code2GOD meaning. The number of termination points of each Hebrew character; the directional position of termination points relative to the four primary directions (i.e. up, down, right, and left); the relative size of individual Hebrew letters compared to one another; and the relative position of individual Hebrew letters within the formal Hebrew alphabet or Alef-Beit provide information for deriving additional secondary or code2GOD meaning. Further, the vibration and fundamental frequency signatures that are inherent to spoken Hebrew letters can be visualized utilizing computer means, which can then be used to derive additional secondary or code2GOD meaning.

The presently disclosed subject matter is built on three foundational strings. The first string is characterized by the original Hebrew bible letter string devoid of spaces and punctuation and consisting 1,197,000 Hebrew letters, particularly arranged and sequenced. The second string equates to the ratio of a circle's circumference to its diameter commonly referred to as the number “Pi” or “η”, the decimal representation thereof never ends or enters a permanently repeating patter. The third string upon which the presently disclosed subject matter builds derives from DNA, the blueprint of known forms of life.

These specifications are particularly directed to the second string and has been referenced hereinabove as the code2GOD system and method, inclusive a computer-implemented code2GOD divine decoder tool. The code2GOD system, method and device decoder tool provides coded numbers only and the interpretation, and conclusions drawn therefrom rely upon numerical values associated with Hebrew words as found within the first string as particularly arranged and sequenced devoid of spaces and punctation. A number of utilitarian aspects derive from these foundational concepts.

A first utilitarian aspect of the code2GOD divine decoder tool is directed to providing numerical bases for informing users how humanity has intelligent design or derives from a divine source as embedded within the first string or Word of God (WOG) and its derivative, the original Hebrew Bible. This utilitarian aspect analyzes Hebrew words and their sub-components, each of which has a code2GOD value that reflects its inherent numerical structure. By performing comparative and computational operations on these values, the code2GOD divine decoder tool reveals correlations between concepts that describe the divine framework for humanity. The following are a few examples:

The Hebrew word [symbol] (“milchama,” war) has the code2GOD value of 123; the sub-word [symbol] (“lechem,” bread), representing survival, has the code2GOD value of 78. The prefix [symbol] (“melach,” salt), is historically associated with money/income, has the code2GOD value of 78. Cross-referencing or the difference between 123 ( [symbol] (“milchama,” war)) and 78 (Dnn (“lechem,” bread)) yields 45, which numerical value corresponds to [symbol] (“adam,” human) as depicted in FIG. 5. This utilitarian aspect demonstrates how the code2GOD divine decoder tool may be utilized to uncover encoded relationships between war, survival, resources, and humanity, thereby providing a system to discover or reveal information about how humanity was intelligently designed or has a divine source from within the first string of the Word of God and its derivative, the original Hebrew Bible. The utilitarian aspect may be further used as affirmation that all living creatures and plants were created by design to continually struggle for survival and success, consistent with Darwinian evolution. At the same time, it is configured to debunk religious rhetoric that depicts Elohim as establishing a peaceful creation, or that attributes the existence of wars, conflict, and bloodshed solely to human failure.

A second utilitarian aspect stemming from the code2GOD divine decoder tool is directed to providing a better understanding of how the structure of matter (elements) is embedded within the first string or Word of God and its derivative, the original Hebrew Bible. A few examples follow: the Hebrew word [symbol] (iom/ium) has the code2GOD value of 56. This word means day, period, or periodical ( [symbol] , machzor), directly corresponding to the periodic structure of the elements. Not coincidentally, the Hebrew word, [symbol] (atom) has the same code2GOD value of 56, confirming the encoded connection between periodicity (iom/ium) and the atomic structure. The fact that 49 chemical elements end with the suffix “-ium” (e.g., sodium, titanium, potassium) is therefore not accidental but evidence of intentional design embedded within the Hebrew language and the code2GOD system. The suffix “-ium” has no other scientific explanation across all 49 elements, but the code2GOD divine decoder tool provides a framework to uncover it. This utilitarian aspect demonstrates that the code2GOD divine decoder tool provides a new framework for understanding the periodic table as divinely structured, rather than a human construct. It enables scientists to approach atomic research with a language-based decoding system, offering a path to results that are faster and cheaper than conventional models such as CERN's particle accelerator experiments.

A third utilitarian aspect according to the presently disclosed subject matter deals primarily with the third string identified above and more particularly described in U.S. patent application Ser. No. 18/092,272 from which these specifications claim a benefit. Searching the medical literature for the exact time it takes the heart of the fetus to become functional (all four chambers developed and the first heartbeat occurs) or the brain of the fetus to become functional (first electrical pulse) is not only challenging but nearly impossible. Clinical research reports inconsistent results with wide variations, depending on methodology and definitions. By contrast, the code2GOD divine decoder tool together with the Chosen One, as described in U.S. patent application Ser. No. 18/092,272, can reveal the exact span in days from the precise conception timestamp (date and time) to the point when each fetal organ becomes functional according to intelligent design or divine source of life. Current science cannot determine the exact moment of conception, nor can it define with certainty what qualifies as a “functioning organ.” The following examples are provided to illustrate this concept: Is the heart considered functional at the very first beat, or only when all four chambers are operating? At which of the five developmental stages of the lungs should they be considered functional?

The code2GOD divine decoder tool resolves these questions with exact values encoded from within the first string or the Word of God. The first example is directed to pregnancy and organ functionality. The Hebrew word [symbol] (heraion, pregnancy) has the code2GOD value of 271, the exact number of days from conception to delivery. Each fetal organ name in Hebrew carries a unique code2GOD value that corresponds to the precise day from conception when that organ becomes functional: For example, the Hebrew word, [symbol] (lev, heart) has the code2GOD value of 32, meaning the heart becomes functional on day 32 (first complete heartbeat with four chambers). The Hebrew word, [symbol] (moach, brain) has the code2GOD value of 48, meaning the brain becomes functional on day 48 (first electrical pulse).

Modern obstetrics estimates conception by asking the woman for the date of her last menstrual period (LMP) and then adding two weeks. This produces a 10-14 day margin of error, which directly impacts organ development calculations: The heart (lev, 32) could be misjudged as functional anywhere between days 22-46. The brain (moach, 48) could be misjudged as functional anywhere between days 34-62. By contrast, the code2GOD divine decoder tool reveals the exact divine day for each organ, eliminating error.

A second example concerns the fertilization of the egg and sperm into a zygote. The Hebrew word [symbol] (beizit, egg) has the code2GOD value of 512, the exact number of ovulations a woman will have in her lifetime. The Hebrew word [symbol] (zera, sperm) has the code2GOD value of 277, the exact number of sperm cells Elohim designed to be released in each ejaculation. The sum 512+277=789, a unique sequential number that corresponds to verse #789 in the original Hebrew Bible:

[symbol]

[symbol]

[symbol]

[symbol]

[symbol]

[symbol]

[symbol]

(Genesis 28:15, OB789; code2GOD 6633)

“And here I am with you, and I will protect you wherever you go, and I shall bring you back to this soil because I will not forsake you until I have done what I have spoken to you.”

This utilitarian aspect demonstrates that the code2GOD divine decoder tool provides exact, divinely embedded biological data about pregnancy, organ development, ovulation, and sperm production. While modem medicine relies on approximations based on patient questioning, the code2GOD divine decoder tool delivers precise numbers far beyond the reach of today's science and affirms the divine design of human life.

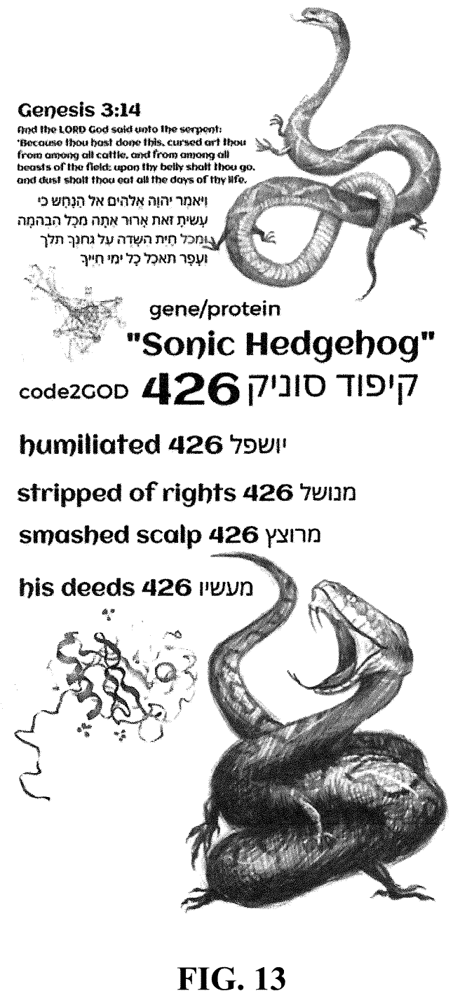

A fourth utilitarian aspect of the code2GOD divine decoder tool stems from its ability to confirm biblical events. For example, reference is made to the sonic hedgehog protein (SHH), which is a major signaling molecule of embryonic development in humans and animals, encoded by the SHH gene. This signaling molecule is key in regulating embryonic morphogenesis in all animals using a concentration gradient SHH further controls organogenesis and the organization of the central nervous system, limbs, digits and many other parts of the body. The reader is directed to FIG. 13 generally comparing Hebrew words, code2GOD values for the words as associated with the sonic hedgehog gene/protein.

A fifth utilitarian aspect of the code2GOD divine decoder tool concerns the principle that not all discoveries are made simply by accessing the system. Based on over 4-6 years of experience, the inventor has determined that revelation through the code2GOD divine decoder tool is intelligently governed by a divine source controlling who, when, and what will be revealed, independent of human intelligence or expertise. In this way, the divine source directs perception itself, controlling conscious awareness and access to discovery.

For example, the Double-Slit Experiment demonstrates that matter behaves differently when observed, suggesting that consciousness plays a role in shaping physical reality. Under the Copenhagen Interpretation, observation collapses quantum potential into a single outcome, implying the presence of a governing intelligence beyond material causality. This indicates that human consciousness is not random, but is linked to—and ultimately governed by—a divine source that sustains reality. In this framework, discoveries through the code2GOD divine decoder tool occur only when permitted by the divine source.

The Double-Slit Experiment reveals that particles exist in a state of pure potential until observed, and the Copenhagen Interpretation teaches that this act of observation brings reality into being. Such a mystery suggests that consciousness is not an accidental byproduct of matter, but is itself woven into the very fabric of creation. In this light, our conscious awareness reflects a higher order—governed by a divine source, the ultimate observer who sustains reality itself.

A second example stems from the Hebrew word, [symbol] (milchania, war) and an analysis of its five Hebrew letters. The middle three letters ( [symbol] , lechem, bread) were revealed, representing survival. However, despite repeated study, the initial three letters ( [symbol] , melach, salt, representing income) remained unseen until such time that the divine source permitted the observer to perceive it. Just as in the Copenhagen Interpretation, observation itself was governed by the divine source determinative of opened perception. This utilitarian aspect demonstrates that the code2GOD divine decoder tool is not solely a mechanical or linguistic tool, but a divinely mediated system. Discoveries are revealed only when the divine source allows the Chosen One to observe them, confirming that human understanding is guided by Elohim's will, not by intellect or method alone.

A sixth utilitarian aspect of the code2GOD Divine Decoder tool is directed to uncovering interpretative clues Elohim embedded in the Hebrew language for astrophysicists to advance discovery of His creation. The Original Bible confirms this function in verse #14, which states: [symbol] [symbol] [symbol] [symbol] [symbol]
“And Elohim said, Let there be lights in the firmament of the skies to divide the day from the night; and let them be for signs, and for seasons, and for days and years.”

The term “signs” in the above verse aligns directly with the purpose of the sixty utilitarian aspect of the code2GOD divine decoder tool. A further example, concerns black holes encoded in Hebrew. The Hebrew word [symbol] (shachor, black) contains within it the sequence [symbol] (chor, hole). This linguistic embedding signifies that the concept of a black hole was already encoded in Elohim's Hebrew language, long before its discovery by modem astrophysics. The structure of Hebrew itself provides astrophysical signs.

A further example is directed to the sun, hydrogen and light travel time. The Hebrew word [symbol] (shemesh, sun) has the code2GOD value of 640. The Hebrew word [symbol] (meyman, hydrogen) has the code2GOD value of 140. The difference between them is 500, which precisely corresponds to the number of seconds required for sunlight to travel from the sun to the earth, as verified by NASA. This utilitarian aspect demonstrates that the code2GOD divine decoder tool can provide astrophysicists with encoded linguistic and numerical signs embedded in Elohim's Hebrew language. These clues, such as the presence of black holes in the word structure itself and the exact light-travel calculation between the sun and earth, confirm that the Hebrew language is not arbitrary but divinely designed as a guide for scientific discovery of the universe.

A seventh utilitarian aspect of the code2GOD divine decoder tool is directed to decoding Elohim's Biblical parables, which otherwise appear as unclear or symbolic stories. By applying the code2GOD divine decoder tool, these parables are revealed as precise mathematical and linguistic frameworks that guide humanity toward maximizing life. Reference is made to the story of Cain and Hevel (Cain and Abel). Cain's name in Elohim's language of the Original Bible is [symbol] (Qayin), pronounced as in English. The name originates from [symbol] (kinyan, property). Cross-referencing with the code2GOD divine decoder tool yields the value 160, which is also the value of [symbol] (kesef, money). Cain therefore represents materialism and property. Hevel's name is [symbol] (hevel), meaning breath or exhalation, symbolizing the human spirit. [symbol] (hevel) has a code2GOD word value of 37, which is also the exact body temperature, further representing the human spirit and vitality.

As revealed through the code2GOD divine decoder tool, the parable of Cain and Hevel is revealed as the inner conflict of material life versus spiritual life. Cain represents the materialistic aspect of life (property, wealth, labor). Hevel represents the spiritual aspect of life (breath, soul, vitality). Elohim preferred the offerings of Hevel, signifying divine preference for spirituality. When materialism (Cain) destroyed spirituality (Hevel) out of jealousy, materialism itself became unbearable and unsustainable. With the help of the code2GOD divine decoder tool, one can now understand Elohim's intent in the Original Bible: that both materialism and spirituality are necessary to maximize human life.

The balance between the two is expressed mathematically. Elohim, who is about numbers and order, prescribed the ratio: one part spiritual to six parts material, as expressed in the commandment of Shabbat, where one day is devoted exclusively to spirituality and six days to material labor. This utilitarian aspect demonstrates that the code2GOD divine decoder tool enables decoding of divine parables into mathematical ratios for living. By revealing the optimal balance between spirituality and materialism, the code2GOD divine decoder provides a framework for maximizing human life according to Elohim's design.

An eighth utilitarian aspect of the code2GOD divine decoder is directed to revealing the divine origin and encoded structure of Biblical names as generally depicted in FIG. 10. By analyzing the Hebrew letters and their arrangement, the code2GOD divine decoder demonstrates how Elohim embedded family lineage, spiritual meaning, and national identity into personal and collective names found in the original Hebrew bible. A first example is demonstrated in the name, [symbol] (Israel). In verse 961 of the original Hebrew bible, the name [symbol] (Israel) is given: “And he said, Your name shall no longer be Jacob, but Israel, for you have struggled with Elohim and with men, and prevailed.”

The name [symbol] (Israel) is composed of Hebrew letters that align with the names of the patriarchs and matriarchs: ′(Yod)−Yakov ( [symbol] ) and Yitzchak ( [symbol] ); [symbol] (Shin)−Sara ( [symbol] ); [symbol] (Reish)−Rachel ( [symbol] )+Rivka ( [symbol] ); [symbol] (Aleph)−Avraham ( [symbol] ); [symbol] (Lamed)−Leah ( [symbol] ). Together, these letters form [symbol] (Israel), integrating both the male and female ancestors of the nation. Referencing FIG. 10, the reader will consider this utilitarian aspect demonstrates that the code2GOD divine decoder reveals Biblical names not as arbitrary labels, but as encoded composites of divine lineage and meaning. The decoding of [symbol] confirms that Elohim intentionally constructed names to carry theological, genealogical, and national significance.

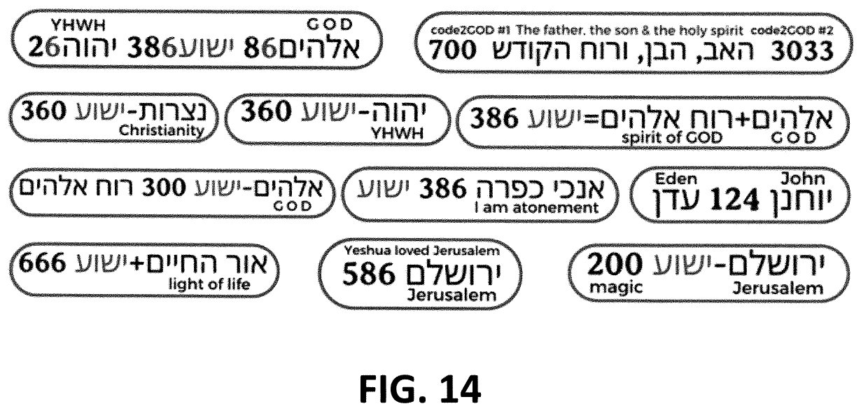

A second example of the eighth utilitarian aspect is demonstrated in the connection to the holiest YHWH as further supported by FIG. 14. The holiest name of God is [symbol] (YHWH) with a code2GOD primary word value 126 of 26. The names of the patriarchs align mathematically as multiples of 26, demonstrating design, not coincidence: [symbol] (Yitzchak, Isaac)=208=8×26; [symbol] (Ya′akov, Jacob)=182=7×26; and [symbol] (Yosef, Joseph)=156=6×26. This demonstrates that the names of the patriarchs are mathematically tied to Elohim's holiest name, confirming intentional divine encoding in the Hebrew language. This utility demonstrates that the code2GOD divine decoder reveals Biblical names not as random identifiers, but as carefully encoded composites of genealogy, mathematics, and divine meaning. The decoding of names such as [symbol] confirms that Elohim intentionally embedded theological truths and mathematical design into the very names of the Bible.

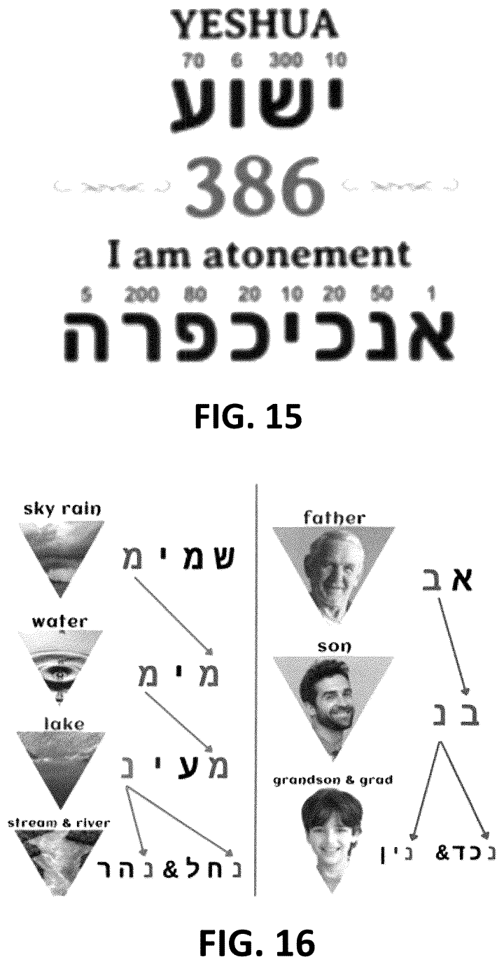

A ninth utilitarian aspect of the code2GOD divine decoder according to the presently disclose subject matter is directed to debunking Christian religious rhetoric as supported by FIGS. 14 and 15. The ninth utility of the code2GOD Divine Decoder is directed to exposing and debunking religious rhetoric fabricated by mistranslations and later theological inventions, particularly those introduced in the King James Bible and perpetuated by religious institutions. By cross-referencing the Hebrew language of Elohim with the code2GOD divine decoder system, distortions are revealed, and the original divine intent is restored.

A first example is demonstrated in the name of the messiah: Yeshua versus Jesus. In the original Yeshua testament (a more accurate translation of the Greek NA28 New Testament, aligned with Yeshua's original spoken Hebrew), the birth prophecy states: [symbol] [symbol] [symbol] [symbol]
“And she will give birth to a boy, and you shall call his name YESHUA, because he will save his people from their sins.”

The name [symbol] (Yeshua) carries the inherent meaning of salvation, confirmed by its code2GOD primary word value 126 of 386, which cross-references to other salvation-related terms. By contrast, the name “Jesus” has no meaning in Hebrew, Greek, Latin, or English, and has no code2GOD value in any language system. It is therefore disconnected from the divine structure. The King James Bible translation—“bring forth a son, and thou shalt call his name JESUS: for he shall save his people from their sins”—is therefore false. The word Jesus neither means salvation nor encodes mathematically into Elohim's language. The code2GOD divine decoder shows that [symbol] (Yeshua) encodes salvation (code2GOD primary word value 126 of 386), whereas the later English form “Jesus” carries no code2GOD meaning. The King James Version standardized the English form within the Church of England, eclipsing alternatives like the Geneva Bible and Douay-Rheims. Using the code2GOD divine decoder, we can debunk the rhetoric born of later translations and restore the original Hebrew intent.

Referencing FIGS. 14 and 15, the reader will consider the following: [symbol] (YHWH)=26; [symbol] (Elohim)=86; [symbol] (Yeshua)=386; [symbol] (I am atonement)=386; [symbol] (The Father, the Son, and the Holy Spirit)=3033; code2GOD first extended number value 134=700; code2GOD second extended number value 135=3033; [symbol] (Christianity-Yeshua)=360; [symbol] (YHWH-Yeshua)=360; [symbol] (Yeshua)=386; [symbol] + [symbol] + [symbol] =386; (spirit of God+God+Yeshua); [symbol] − [symbol] (God-spirit of God-Yeshua)=300; [symbol] (John)=124; [symbol] (Eden)=124; [symbol] + [symbol] (Light of life+Yeshua)=666; [symbol] (Jerusalem)=586; [symbol] (Jerusalem-Yeshua)=200.

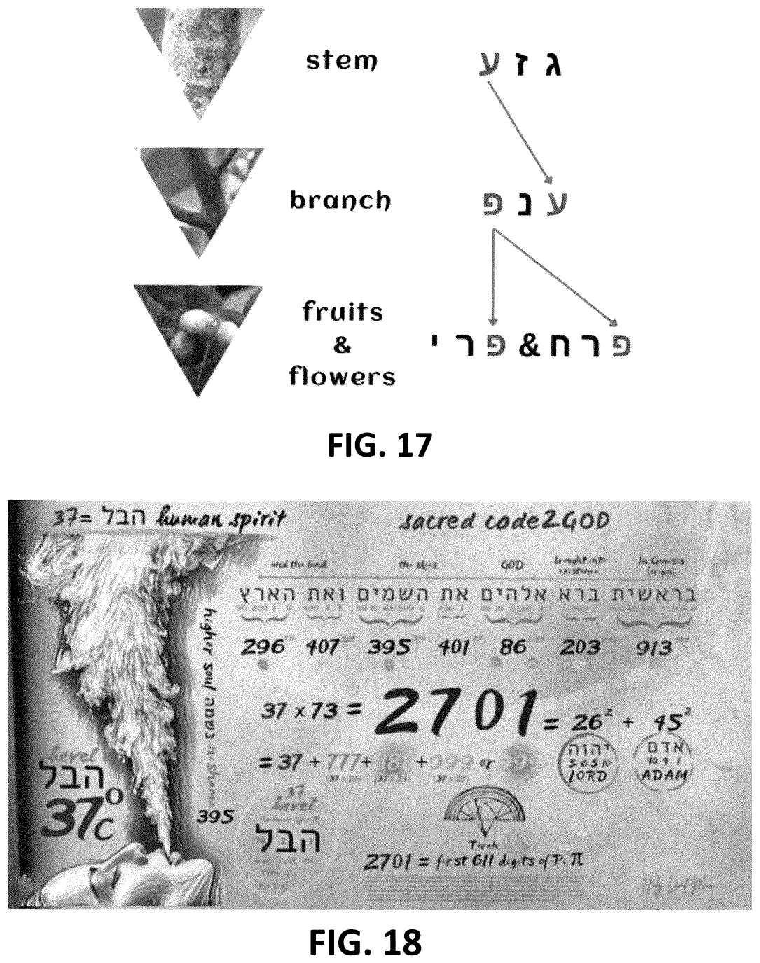

A tenth utilitarian aspect of the code2GOD divine decoder is directed to discovering inherent divine proof of the creator in the Hebrew language as supported by FIGS. 16 and 17. The Hebrew language, designed by Elohim, contains a built-in chaining system where the last letter of one word becomes the first letter of the next logical word in the same category. To clarify for non-Hebrew speakers: some Hebrew letters have two shapes—a “regular” form (used in the beginning or middle of a word) and a “final” form (used only at the end of a word). Example: [symbol] (nun) and [symbol] (final nun) are the same letter. Example: [symbol] (mem) and [symbol] (final mem) are the same letter. Thus, even if a word ends with a final form, the chain continues naturally into the next word.

Comparatively referencing FIGS. 16 and 17, the reader will consider the following examples. A water hierarchy (nature) structure is demonstrated by the following: [symbol] (shamayim, skies/rain)→ends with [symbol] (final mem=regular [symbol] )→leads to . . . [symbol] (mayim, water)→ends with [symbol] (final mem=regular [symbol] )→leads to . . . [symbol] (ma′ayan, spring/lake)→ends with [symbol] (final nun=regular [symbol] )→leads to . . . [symbol] / [symbol] (nahar, river/nachal, stream). Chain: [symbol] ] [symbol] ]→ [symbol] ] [symbol] → [symbol] ]→ [symbol] / [symbol] . Here the chain perfectly mirrors the natural flow of water:rain→water→spring→river.

Generations (Family Lineage) is further considered as a second example. [symbol] (av, father)→ends with [symbol] →leads to . . . [symbol] (ben, son)→ends with [symbol] (final nun= [symbol] )→leads to . . . [symbol] / [symbol] =(neched, grandson/nin, great-grandson); Chain: [symbol] → [symbol] ] [symbol] → [symbol] ]→ [symbol] / [symbol] . This reflects the progression of family generations: father→son→grandson. A third example is demonstrated by Botany (Plant Growth). [symbol] (geza, stem)→ends with [symbol] →leads to . . . [symbol] (anaf, branch)→ends with [symbol] (final pe= [symbol] )→leads to . . . [symbol] / [symbol] (pri, fruit/perach, flower). Chain: [symbol] → [symbol] [symbol] ] [symbol] →]→ [symbol] / [symbol] . This mirrors the biological progression of plants: stem→branch→fruit/flower.

Logical Sequences: The chains exemplified above perfectly align with natural hierarchies (rain→water→spring→river; father→son→grandson; stem→branch→fruit). This requires pre-planned vocabulary construction beyond the ability of early human language inventors. The same last→first principle applies to nature, biology, and family. The chance of multiple coherent chains existing naturally is mathematically negligible. Utilitarian aspect number 10 shows that Hebrew is not a man-made language, but a divinely engineered system where the last letter of one word becomes the gateway to the next word in the logical sequence of creation. This built-in continuity is proof that Hebrew is God's language, reflecting His design of life and the universe.

An eleventh utilitarian aspect of the code2GOD divine decoder is directed to understanding the creation of life and the universe as supported by FIG. 18. The eleventh utility of the code2GOD divine decoder is directed to decoding original Hebrew bible verse #1 (Genesis 1:1) to reveal the mathematical blueprint by which Elohim created life and the universe. Using code2GOD primary word values 126 for each Hebrew word, the code2GOD divine decoder exposes an integrated structure linking divine identity, human life, spirit, the skies and the earth, and even π as generally depicted in FIG. 18 and exemplified by the following: Genesis 1:1 Numerical Matrix (word-by-word):
[symbol] “In Genesis/origin” has the code2GOD value of 913
[symbol] “brought into existence” has the code2GOD value of 203
[symbol] “Elohim/GOD” has the code2GOD value of 86
[symbol] “et” (alphabetic marker, Alef-Tav) has the code2GOD value of 401
[symbol] “the skies/heavens” has the code2GOD value of 395
[symbol] “and-et” has the code2GOD value of 407
[symbol] “the land/earth” has the code2GOD value of 296
   Verification of the whole verse (add carefully, left-to-right):

$$\begin{matrix}296 + 407 = 703 ; \\ 703 + 395 = 1,098 ; \\ 1,098 + 401 = 1,499 ; \\ 1,499 + 86 = 1,585 ; \\ 1,585 + 203 = 1,788 ; \\ 1,788 + 913 = 2,701 .\end{matrix}$$

Therefore, Genesis 1:1 has the code2GOD value of 2,701.

Core identities revealed by the code2GOD divine decoder; Factorization of creation: 2,701=37×73. (30×73=2,190; 7×73=511; total 2,701.); Divine-Human synthesis: 2,701=26²+45²; [symbol] (YHWH) has the code2GOD value of 26→26²=676; [symbol] (adam, human) has the code2GOD value of 45→45²=2,025; 676+2,025=2,701. Creation is encoded as the sum of the squares of God (26) and Human (45). The human spirit (life-breath): [symbol] (hevel, breath/spirit) has the code2GOD value of 37. Body temperature: 37° C.→life is sustained at the number that factors creation. Repeating-digit confirmation: 37+777+888+999=2,701 (37×21=777, 37×24=888, 37×27=999; 37+777+888+999=2,701). Heavens and the higher soul: [symbol] (the heavens) has the code2GOD value of 395, and [symbol] (neshama, higher soul) has the code2GOD value of 395. The code2GOD divine decoder reveals an equivalence between the heavens and the higher soul, linking cosmology with human consciousness.

Alphabetic scaffold ( [symbol] /Alef-Tav): [symbol] has the code2GOD value of 401, the marker of the full Hebrew range [symbol] (first to last). The verse explicitly embeds the complete language domain used to bring creation into existence. Torah and π (always digits after the decimal): [symbol] (Torah) has the code2GOD value of 611. The code2GOD property: the sum of the first 611 digits of π after the decimal equals 2,701. Torah↔π linkage: language of law/instruction mirrors the mathematics of creation. The code2GOD divine decoder Provides a single, testable numerical framework where God (26), Human (45), Spirit/Life (37/37° C.), Heavens (395), Earth (296), and the language scaffold (401) integrate to 2,701, the value of Genesis 1:1.

The code2GOD divine decoder shows creation as a designed synthesis: divine identity and human existence combine quadratically (26²+45²) to produce the totality of the creation statement. The code2GOD divine decoder connects cosmology ( [symbol] ) to consciousness ( [symbol] ) via exact equality (395). The code2GOD divine decoder anchors the creation code to π through Torah=611, with the sum of the first 611 π-digits (post-decimal) equaling 2,701. The eleventh utilitarian aspect demonstrates that the code2GOD divine decoder decodes [symbol] into a comprehensive mathematical architecture for life and the universe, uniting Divine name, human identity, spirit, language, cosmology, earth, and π in one exact, reproducible system.

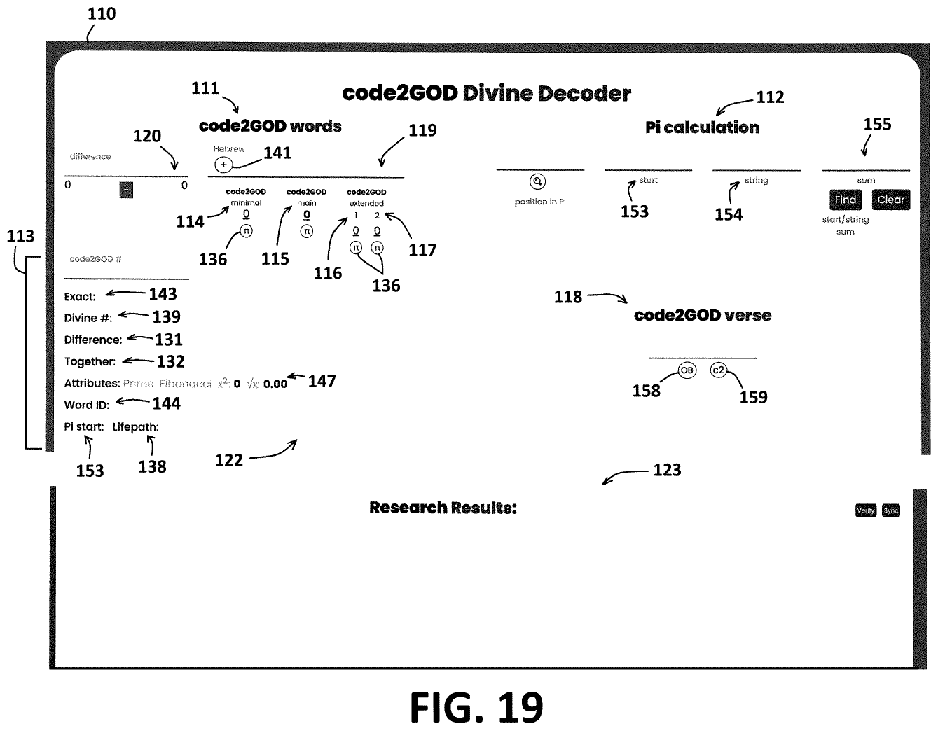

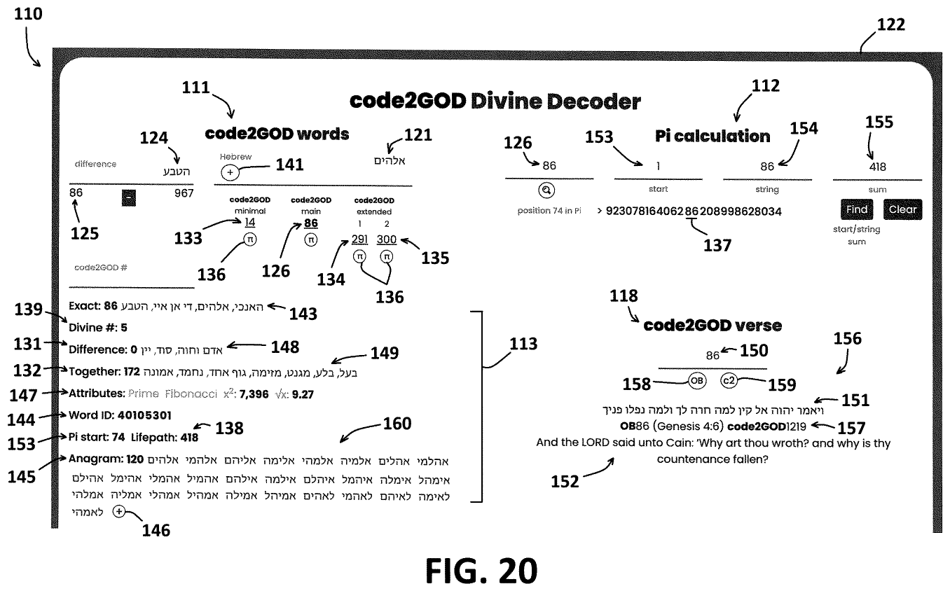

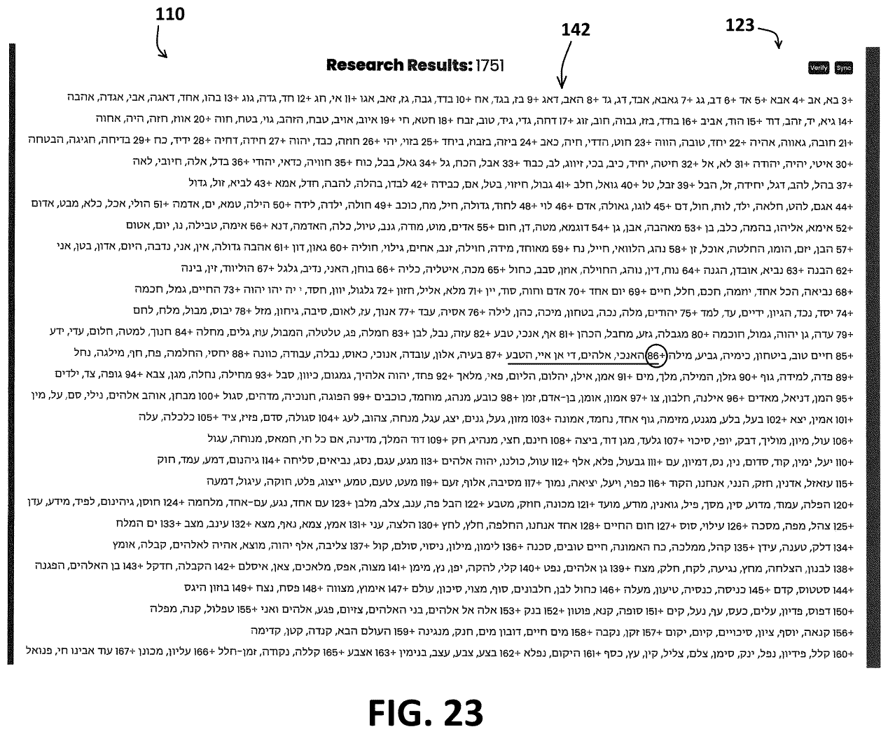

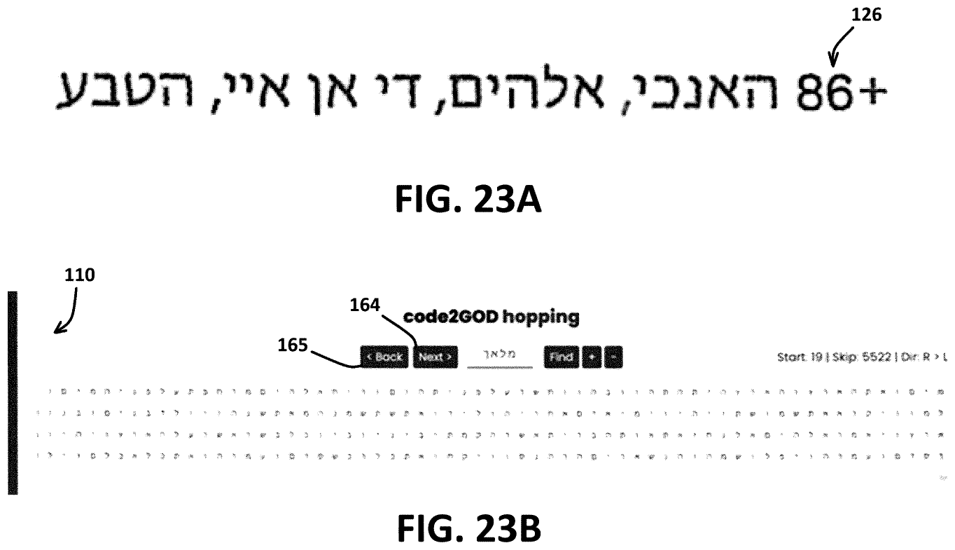

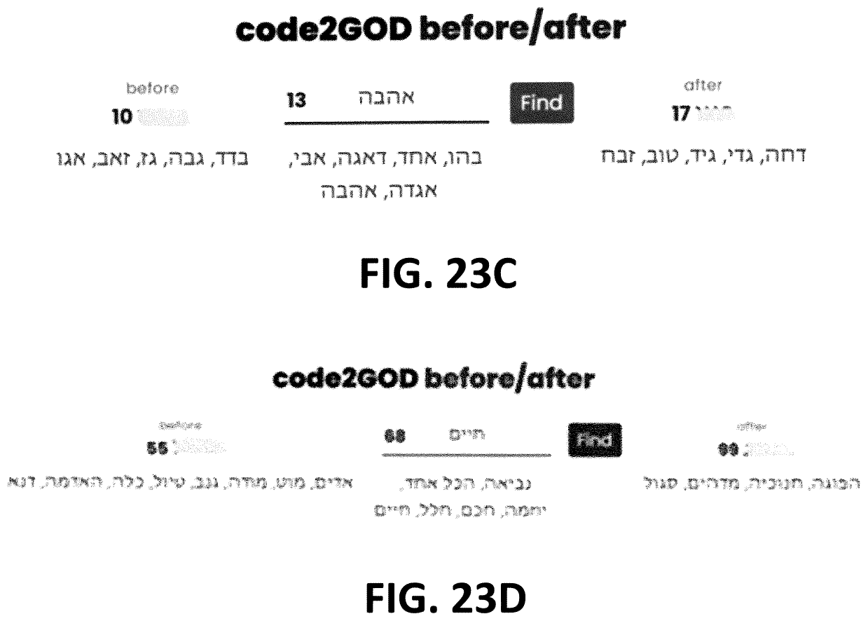

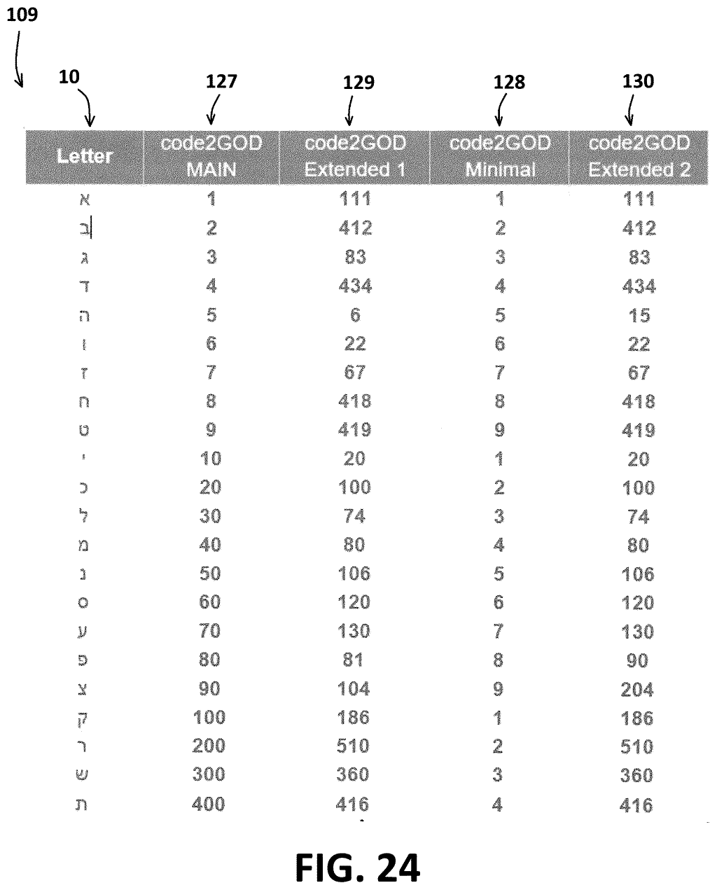

The code2GOD divine decoder tool according to the presently disclosed subject matter is computer-implemented and driven by a non-transitory, computer-implementable software-based application and provides outputs based on the pre-compiled original Hebrew bible string devoid of spaces and punctuation and consisting of 1,197,000 Hebrew letters as described hereinabove. A graphical user interface of the decoder tool is variously depicted and referenced at 110 in FIGS. 19-23D and a value table 109 is presented in FIG. 24 for reference in support of the decoder tool. In some applications, the graphical user interface (GUI) 110 of the decoder tool comprises an upper GUI portion 122 and a lower GUI portion 123. The upper GUI portion 122 is depicted and referenced in FIGS. 19 and 20 and the lower GUI portion 123 is depicted and referenced in FIGS. 19 and 23. In some applications, the upper GUI portion 122 presents numerical and detailed outputs and the lower GUI portion 123 presents research results.

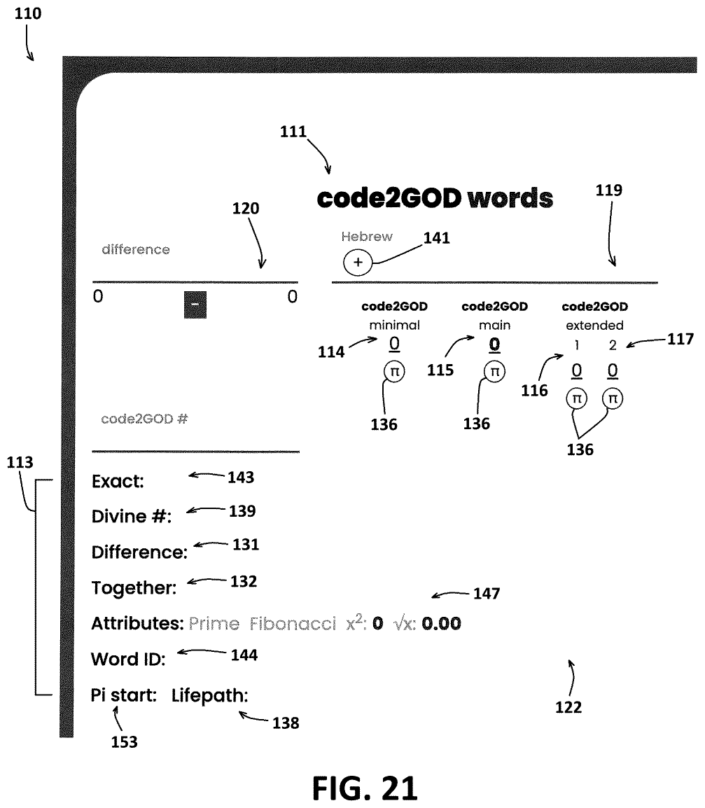

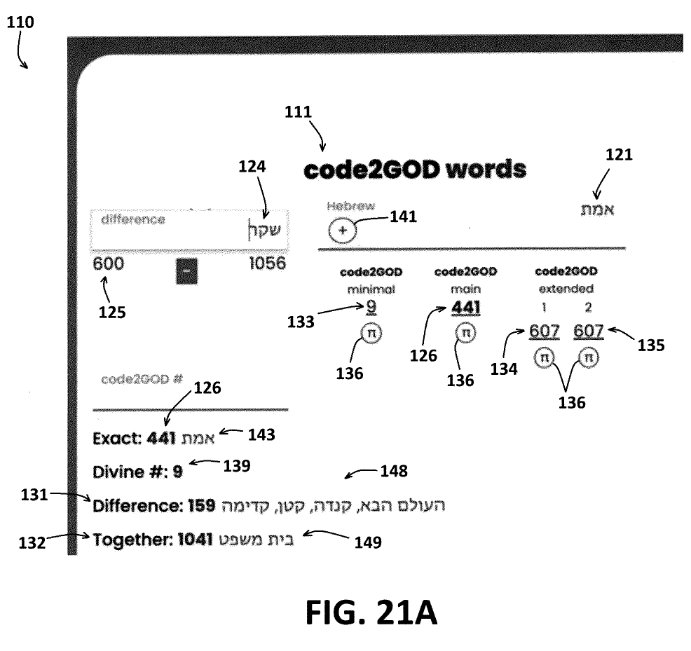

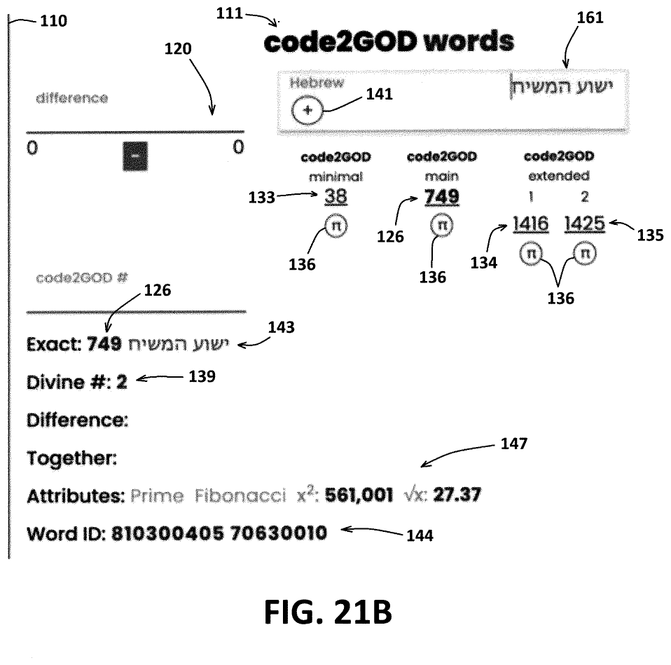

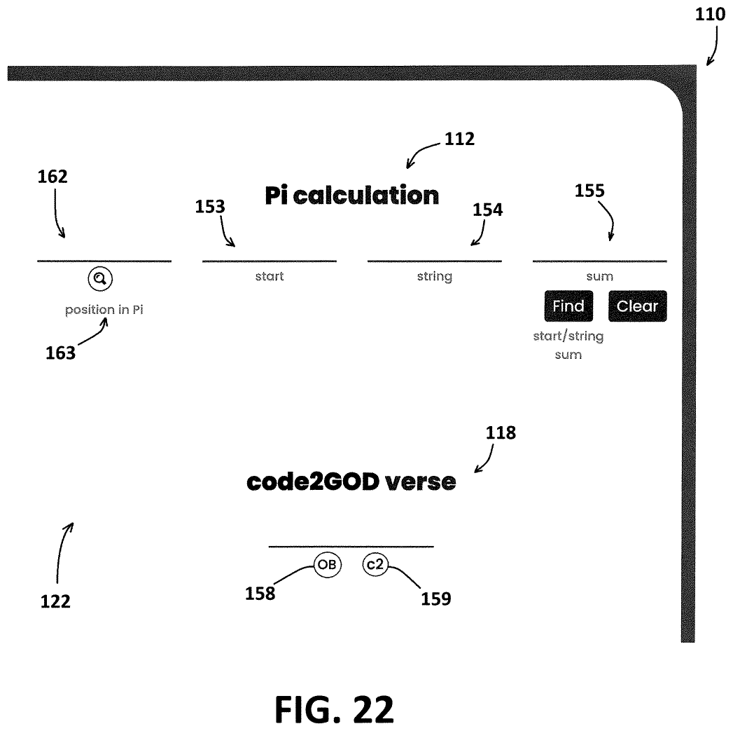

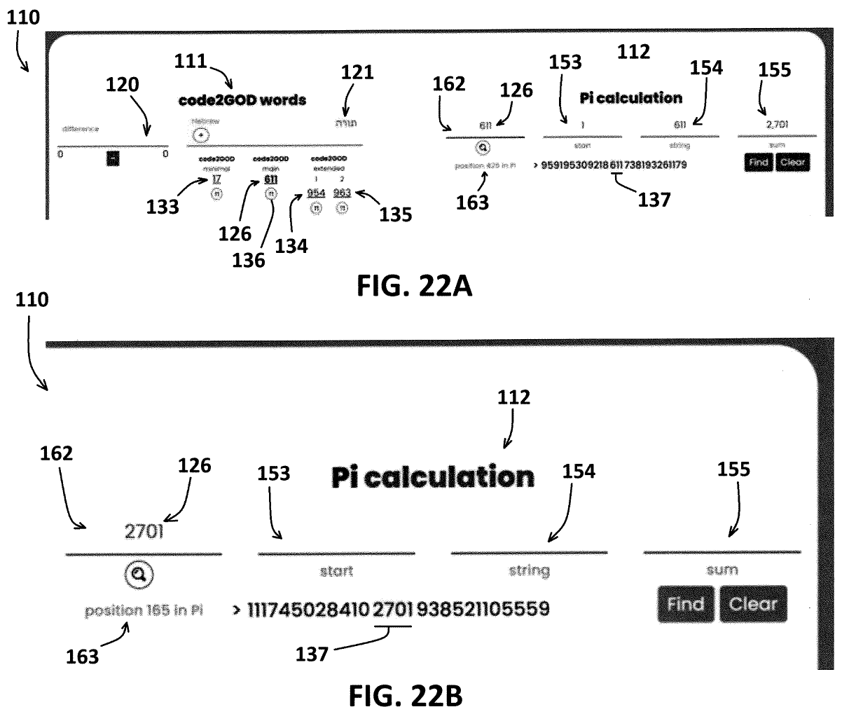

A Hebrew word input portion 111 is referenced at the left side of the upper GUI portion 122 as further depicted in FIGS. 21-21B and a Pi calculation portion 112 is referenced at the right side of the upper GUI portion 122 as further depicted in FIGS. 22-22. In some applications, the upper GUI portion 122 of the graphical user interface 110 may comprise a number of output portions, including a minimal number value output 114, a main number value output 115, a first extended number value output 116, and a second extended number value output 117. In some applications an array of other value outputs are provided as at 113 and in some applications a verse output portion 118 is provided as described in more detail below.

The decoder tool according to the presently disclosed subject matter enables a user to derive divine messaging from reference Hebrew words as input at the Hebrew word input portion 111. A reference Hebrew word 121 may be typed in or otherwise input as at reference word input portion 119, which reference Hebrew word has a primary meaning. Once a reference Hebrew word is input at the reference word input portion 119, the decoder tool populates at least the output portions 113-118. FIG. 19 depicts a blank graphical user interface 110 and FIG. 20 depicts a populated graphical user interface 110′. An exemplary reference Hebrew word 121 is referenced in FIG. 20. Further referencing FIG. 20, the reader will consider a number of output values and other details associated with the reference Hebrew word 121 as populated at the output portions 113-118.

In some applications, the decoder tool automatically populates the output portions 113-118 with correlated secondary word values and other details once the reference Hebrew word 121 is input into the decoder tool at the reference word input portion 119. A primary word value or main word value is referenced at 126 in FIG. 20 as output at the main number value output 115. The primary word value 126 in the example provided is 86, which is the sum of the individual Hebrew letter values for the reference Hebrew word shown in FIG. 20. The individual Hebrew letter values are referenced at 127 in FIG. 24. Referencing tabular FIG. 24, the reader will further consider the various letter values 127 for each of the 22 Hebrew letters as set forth in column 10 juxtaposed adjacent the main letter values are presented in the column referenced at 127. The reader may wish to also refer back to FIG. 1 in which the letter values are referenced at 129.

The primary word value 126 or ‘main’ value provided by the code2GOD divine decoder is one of 4 numerical values assigned to each Hebrew word. The primary word value 126 calculation is presented as a number as at “86” in the example depicted in FIG. 20 and as at “441” in the example depicted in FIG. 21A. In some applications, the primary word value 126 is provided with an underlined hyperlink, which, when activated, populates and executes the “Pi calculation” as at 112. This action yields the sum of the first ‘n’ digits of Pi (after the decimal point), where ‘n’ is determined by the code2GOD ‘minimal’ output value 133. The first 86 digits after the decimal point are depicted in FIG. 20. In some applications, the primary word value hyperlink may also populate the code2GOD verse field 118 with the verse number 150, the verse in the original Hebrew bible format as at 151, an English (or other language) version as at 152, and the primary word value 126.

The various output portions as at 113-118 represent secondary word values, which the user may then use to interpret the primary meaning of the reference Hebrew word 121. Secondary meaning derived from the secondary word values may be considered a form of divine messaging from within the Hebrew bible letter string, which secondary meaning may help or bolster an understanding of the primary meaning of the reference Hebrew word 121. In some applications, at least one comparison Hebrew word 124 may be input at input portion 120 for comparison to the reference Hebrew word 121 as depicted and referenced in FIGS. 20 and 21A. The computer-implementable software-based application, the computer, and the graphical user interface 110 are together configured to output a comparison word value 125 associated with the comparison Hebrew word 124. The decoder tool then calculates and outputs a word difference value 131 as derived from the primary word value 126 and the comparison word value 125.

The word difference value 131 is associated with at least one third Hebrew word. In other words, the word difference value 131 is associated with any number of Hebrew words whose primary word value 126 is equal to the word difference value 131. In some applications, a listing 148 of exemplary ‘difference’ Hebrew words may be populated upon the graphical user interface next to the word difference value 131 as generally depicted in FIG. 20. The user is then enabled to interpret the primary meaning of the reference Hebrew word 121 in view of the comparison Hebrew word 124 and the at least one third Hebrew word derived from the word difference value 131 thereby providing tertiary meaning reflective of divine messaging from within the Hebrew bible letter string, which tertiary meaning bolsters the understanding of the primary meaning.

The word difference value 131 quantifies the numerical code2GOD disparity between two words or terms to elucidate God's message to humanity. A s depicted in FIG. 21A, the difference between the reference Hebrew word 121 entered in reference word input portion 119, “emet” ( [symbol] ), meaning “truth,” with a code2GOD primary, word value of 441, and the comparison Hebrew word 124 entered into comparison word input portion 120, “sheker” ( [symbol] ) meaning “lie,” with a code2GOD comparison word value of 600, is exhibited as word difference value 131 of 159, which translates to “katan” ( [symbol] ) meaning, small.

The decoder tool according to the presently disclosed subject matter may further, in some applications, provide a word sum value or ‘together’ value as at 132 in FIG. 20. In this regard, in some applications, the computer-implementable software-based application, the computer, and the graphical user interface are together configured to calculate and output the word sum value 132 as derived from the summation of the primary word value 126 and the comparison word value 125. The word sum value 132 may be associated with at least one fourth Hebrew word. In some applications, a listing 149 of exemplary sum or ‘together’ Hebrew words may be populated upon the graphical user interface next to the word sum value 132 as generally depicted in FIG. 20.

As with the word difference value 131, the user is thereby enabled to interpret the primary meaning of the reference Hebrew word 121 in view of the comparison Hebrew word 124 and the at least one fourth Hebrew word thereby providing quaternary meaning reflective of divine messaging from within the Hebrew bible letter string, which quaternary meaning bolsters the understanding of the primary meaning. Secondary Hebrew entry terms are intended to determine the numerical code2GOD word difference value 131 and word sum value 132 so as to enable the user to subsequently infer additional divine messages to humanity. For instance, the difference between emet [symbol] (truth) 441 and sheker [symbol] (lie) 600 is 159, which translates to [symbol] katan. In the shown example depicted in FIG. 21A, their combined value is code2GOD 1041, signifying [symbol] beit mishpat (courthouse).

The word sum value 132 or ‘Together’ feature provides sum values of the Hebrew words/terms from the reference Hebrew word 121 and the comparison Hebrew word 124 to reveal further insights into God's messaging to humanity and/or human design. As depicted in FIG. 21A, the code2GOD divine decoder yields a word sum value 132 of 1041, precisely matching the code2GOD value for [symbol] “beit mishpat” (courthouse). The divine message conveyed is that while the disparity between truth and falsehood may be minor, such matters should be resolved within a courthouse, rather than through violence (“alimot”). The reader will note the word [symbol] “the next world” as an alternative to code2GOD word sum value 132 of 1041 indicating perhaps that the truth will be revealed after death.

Further referencing FIG. 24, the reader will consider column 128 setting forth ‘minimal’ number values associated with each Hebrew letter as otherwise referenced at 10. In this regard, the reference Hebrew word 121 consists of a number of individual Hebrew letters 10, each of which are associated with a minimal letter value 128. The minimal letter values 128 of each individual Hebrew letter 10 within the reference Hebrew word 121 are summed by the decoder tool to provide a total minimal number value or ‘minimal’ output value 133 upon the graphical user interface 110 for bolstering the understanding of the primary meaning.

In some applications, the decoder tool may further provide a first ‘extended’ number value as introduced at 134 in FIG. 20 and a second ‘extended’ number value as introduced at 135 in FIG. 20. Comparatively referencing FIGS. 1 and 24, the reader will consider the individual Hebrew letters 10 are associated with a letter name as at column 12 in FIG. 1. The individual letters within a letter name are summed to provide a letter name value or first extended number value as set forth in column 129 in FIG. 24 and column 13 in FIG. 1. In some applications, the letter name values 129 of each individual Hebrew letter 10 within the reference Hebrew word 121 are summed to provide the first ‘extended’ number value 134 upon the graphical user interface 110 for bolstering the understanding of the primary meaning. Noting that select Hebrew letters of the individual Hebrew letters 10 are associated with a plurality of letter name values, the plurality of letter name values of the select Hebrew letters may be summed with the first extended number value 134 to provide or yield the second ‘extended’ number value 135 upon the graphical user interface 110 for bolstering the understanding of the primary meaning. The second ‘extended’ number values for the Hebrew letters 10 are presented in column 130 in FIG. 24.

The first ‘extended’ number value 134 outcome calculation is presented as “291” in FIG. 20 and may be provided with an underlined hyperlink, which, when activated, populates and executes the “Pi calculation” portion 112. This action yields the sum of the first ‘n’ digits of Pi (after the decimal point), where ‘n’ is determined by the code2GOD first ‘extended” number value 134 or the first 291 digits. Upon activation of a Pi locator feature or button 136 or the “π” symbol within a circle, the position of the code2GOD first ‘extended” number value 134 is revealed within the infinite string of Pi's digits at the Pi calculation portion 112. The second ‘extended’ number value 135 is presented as a number “300” in FIG. 20 and has an underlined hyperlink, which, when activated, populates and executes the “Pi calculation” portion 112. This action yields the sum of the first ‘n’ digits of Pi (after the decimal point), where ‘n’ is determined by the code2GOD second ‘extended’ number value or the first 300 digits. Upon activation of the Pi locator feature 136, the position of the code2GOD second ‘extended’ number value 135 is revealed within the infinite string of Pi's digits. The reader will note FIG. 20 depicts the activation of the Pi locator feature 136 for the primary word value 126.

Turning now the Pi calculation output portion 112, it will be recalled the decoder tool is primarily based on the first string basis or original Hebrew bible letter string, and secondarily based on the second string basis, including Pi and its infinite Pi string consisting of those digits following the decimal or numerical presentation of the ratio of a circle's circumference to its diameter. The infinite number of Pi was first revealed in the inaugural verse of the original Hebrew bible letter string, which serves as the foundational text for much of the code2GOD divine decoder. This verse comprises 22 letters (analogous to Elohim's number of Hebrew letters) distributed across 7 words, yielding a ratio of abbreviated 3.14.

Referencing FIG. 22A, the user may start by inputting the primary word (or verse) value 126 into the code2GOD value search entry portion 162 of the Pi calculation portion 112 with a start position or portion 153 of 1 and further specify the number of digits to be summed as at string portion 154. These fields may populate by selecting the Pi locator feature 136 associated with the primary word value 126. A sum output portion 155 sums all the digits within the Pi string from the start portion 153 along a length of the Pi string as governed by value at the string portion 154. This example illustrates a profound connection between the Elohim's Bible, known as the Torah ( [symbol] ), and the mathematical constant Pi. The numerical value assigned to the word Torah, using a system referred to as “code2GOD,” is 611. Remarkably, the first 611 digits of Pi sum to 2,701, which precisely matches the “code2GOD” value of the Bible's inaugural verse: [symbol] [symbol] [symbol] (In the beginning, Elohim brought into existence, out of nothing, the heavens and the earth).

The code2GOD divine decoder identifies the starting digit of a divine message to humanity within the infinite string of Pi. Specifically, referencing FIG. 22B, the position in Pi 163 of the verse of creation having a code2GOD value of 2701 is input at a code2GOD value search entry portion 162. The code2GOD value of 2701 elucidates the genesis of creation, as code2GOD position 163 of 165, “ [symbol] ” (nekuda−point/dot) within the Pi string, symbolizing the Big Bang. This interpretation is further supported by cross-referencing additional information from code2GOD divine decoder, which designates the position 163 as a “central point” with verifiable numerical scientific foundations within the Pi calculation portion 112 of the code2GOD divine decoder.

In this regard, it will be recalled In this regard, the reader is directed to a Pi locator feature 136 associated with output number values corresponding to the primary word value 126, the ‘minimal’ output value 133, the first ‘extended’ number value 134 and the second ‘extended’ number value 135. The Pi locator feature 136 may be selected to locate a select output number value from the output number values within the Pi string at a number location as at 137, which number location 137 bolsters the understanding of the primary meaning. Upon activation of the Pi locator feature 136 (a “π” symbol within a circle) at the ‘minimal’ output value 133, the position of the code2GOD ‘minimal’ number is revealed within the infinite string of Pi's digits.

In the example shown in FIG. 20, the main number Pi locator feature 136 is selected and the primary word value 126 is located and highlighted at the number location 137. The primary word value 86 is located at position 74 within the Pi string. In some applications, the decoder tool may provide a lifepath output value as at 138. The lifepath output value 138 is derived by summing Pi string digits from the number location 137 along a string length equal to the select output number value, which in the example provided is 86. Summing the 86 digits from position 74 yields a lifepath output value of 418 which may bolster the understanding of the primary meaning. The Pi locator feature(s) 136 denote a numerical position derived from the infinite Pi string. The lifepath output value 138 for a primary word value 126 represents the cumulative sum of the initial ‘n’ values from the code2GOD primary word value. 126, which, in some applications, may further reference the verse number within the original 1-Hebrew bible letter string (comprising 23,206 verses numbered sequentially from 1 to 23.206), without he need for book numbers, chapters, or verses.

In some applications, the decoder tool is configured to provide single reduced numerical value or ‘divine’ output value as at 139. In this regard, a select numerical letter value of each Hebrew letter 10 in the reference Hebrew word 121 is summed to provide the single reduced numerical value 139. In some applications, the single reduced numerical value 139 may be either (a) between a range of values from 1 to 9; (b) equal to 10; or (c) a select unique numerical value selected from the group consisting of 11, 22, 33, and 44. In some applications, the single reduced numerical value 139 may be solely within the range of values from 1 to 9. The single reduced numerical value or ‘divine’ number is derived by summing all single-digit numbers within the primary word value 126, iteratively adding the digits until a single digit is obtained, which may bolster the understanding of the primary meaning.

In some applications, the decoder tool according to the presently disclosed subject matter may populate a verse 140 from within the Hebrew bible letter string as associated with the primary word value 126. In other words, the decoder tool may output upon the graphical user interface 110, a verse 140 from the Hebrew bible letter string associated with the primary word value 126 for bolstering the understanding of the primary meaning. In the example provided in FIG. 20, verse 86 from within the Hebrew bible letter string is associated with the primary word value 126 of 86 and is output upon the graphical user interface 110 at the verse output portion 118.

The code2GOD verse feature 156 is an original Hebrew bible letter string and code2GOD value search engine. The original Hebrew bible letter string, comprising 23,206 verse numerically ordered from 1 to 23,206 obviates the necessity of citing book, chapter, and verse, This system functions as a search engine for these 23,206 original Hebrew Bible verses as at 151, providing their English translations 152 and the corresponding code2GOD verse value 157 for each verse, The OB circle feature or button 158, when activated, conducts searches based on the verse number. The C2 circle feature or button 159 retrieves all Original Bible verses corresponding to a specified Code2GOD value.

In some applications, the decoder tool may further comprise a research results add feature as at + sign 141. By selecting the + sign research results add feature, the reference Hebrew word is added to a research results compilation as at 142 as associated with the primary word value 126 for bolstering the understanding of the primary meaning. In other words, The “+” symbol will incorporate the primary word value 126 of the reference Hebrew word 121 only into a research results compilation 142 and groups Hebrew terms based on their primary word values 126. The research results compilation 142 is a compendium of Hebrew words and their corresponding code2GOD primary word values 126. These entries are categorized b similar values, forming a valuable repository of insights into optimizing human life and well-being, and understanding the divine design of humanity.

Comparatively referencing FIGS. 23 and 23A, the reader will consider all Hebrew words to date that have been associated with a primary word value 126 of 86. In some applications, a primary word value summary feature or ‘exact’ feature 143 provides a listing of Hebrew words for any given primary word value 126. In some applications, the primary word value summary feature 143 is configured to output or populate all Hebrew words within the Hebrew bible letter string associated with the primary word value 126 upon the graphical user interface 110 for bolstering an understanding of the primary meaning.

The primary word summary feature 143 is denoted as “Exact” in FIG. 20. In some applications, this feature 143 displays all Hebrew words from the research results compilation 142 that precisely match the code2GOD primary word value 126. In the example provided, the Hebrew word [symbol] (Elohim), meaning “God,” yields a code2GOD primary word value of 86. The “Exact” field reveals two significant scientific discoveries: Elohim ( [symbol] ), meaning “God,” possesses the same code2GOD (86) as the Hebrew word HaTeva ( [symbol] ), meaning “The Nature.” This finding corroborates Einstein's theory concerning God, which was influenced by the renowned philosopher Spinoza. Elohim ( [symbol] ), meaning “God,” shares the same code2GOD (86) as the Hebrew term “ [symbol] (DNA). This confirms that God is either an integral component of human DNA or was its creator/designer.

The code2GOD divine decoder may further comprise an ‘attributes’ feature as at 147, which outputs additional mathematical computations such as prime, Fibonacci, square number, and root collectively as at 154. These are beneficial for analyzing psychological elements like ego ( [symbol] ani 61) and super-ego ( [symbol] anuch 81). Notably, the ego (ani 61) yields a prime number, divisible only by itself, while the supery-ego (code2GOD 81) possesses a root of 9, signifying “completeness.” In some applications, the array of other value outputs 113 may include a word identification output value as at 144 and an anagram number value as at 145. The word identification output value 144 is akin to a serial number for the reference Hebrew word 121 and consists of letter values for each Hebrew letter.

In the example provided in FIG. 20 for the reference Hebrew word 121 from right to left, the numbers are 1, 30, 5, 10 and 40. The reader will note that these letter values sum to the primary word value of 86. Each Hebrew letter within a Hebrew word is mirrored with its corresponding code2GOD value, as illustrated in the image below: Yeshua HaMashiach ( [symbol] [symbol] ), translated as “Yeshua The Messiah,” holds the word identification 145 of 810300405 70630010 as depicted in FIG. 21B. In the example depicted in FIG. 21B, the reference Hebrew phrase is referenced at 161

The anagram number value 145 totals the number of anagrams possible for the reference Hebrew word 121. In the example provided, a full listing of the anagrams can be accessed by selecting the + sign 146. Only a partial listing 160 of anagrams is shown in FIG. 20 for ease of illustration. Each Hebrew word, divinely originated, possesses a unique code2GOD primary word value 126. A rearrangement of its constituent letters can unveil additional words. These newly discovered words inherently share the identical code2GOD primary word value 126 and transmit the same divine message to humanity. For instance, the word [symbol] (tzara), meaning “disaster,” with a code2GOD value of 295, has an anagram in [symbol] (tzohar), signifying “bright light shining through a tiny hole in the darkness.” This exemplifies Elohim's perspective on human difficulties: they are not disasters but rather detours, for which one will express gratitude subsequently.

The code2GOD divine decoder may further provide a code2GOD hopping feature as generally depicted in FIG. 23B and a code2GOD before/after utility as generally depicted in FIG. 23C. The code2GOD hopping feature unveils divine messaging in people, events, and terms. The code2GOD system processes a given word or term by searching the Word of God (WOG), a string of 1,197,000 Hebrew letters devoid of punctuation and spacing, for a specific scientific mathematical letter formula. The results, including the formula, are presented in a tabular format. For instance, the word [symbol] (malach), meaning “angel,” yielded the formula: “Start: 19|Hopping: 5522|Dir: R>L.”

This indicates that the first letter, n (mem), is located at the 19th position within the Word of God. Subsequently, the system skips 5522 letters to identify the second letter, [symbol] (lamed), and so on, proceeding in a right-to-left direction (an opposite direction is also permissible). The discovery of the code2GOD occurs when additional related words become discernible within the seemingly random table, appearing in any direction, such as diagonally or from bottom to top. Only words related to the initial entry term are to be considered. The “Next” and “Back” buttons 164 and 165 reveal the next and previous formulas.

The code2GOD before/after utility depicted in FIG. 23C provides insights into the antecedents and consequences of events or terms. For example, consider the term, Love ( [symbol] ): preceding “love” ( [symbol] ): “loneliness,” “wolf,” and “ego”; and succeeding “love” ( [symbol] ): “good,” “rejection,” and “sacrifice”. Further referencing FIG. 23D, the reader will consider a second example. The Hebrew word “ [symbol] ” (life) yields the “code2GOD” clue results for Holy Land Man's study and interpretation. Prior to” “ [symbol] ” (life): “DNA” (biochemical fact) and “The Soil” (biblical fact). Subsequent to: “ [symbol] ” (life): “amazing,” “pause,” and “purple,” each possessing discernible and interpretable meaning by Holy Land Man.

While the foregoing descriptions contain certain specificity, this specificity should not be construed as limitations on the scope of the invention, but rather as an exemplification of the invention. The code2GOD divine decoder can help users learn how to achieve a purposeful life. The code2GOD divine decoder can help users correct scientific assumptions. For example, humans assume the day starts at midnight, which is neither the middle of the night nor has any scientific or human behavior explanation. Based on the Original Bible and the code2GOD divine decoder, the day starts when the sun sets as Elohim mentions six times in Genesis “let it be evening, let it be morning”.

The code2GOD divine decoder further provides information on how to maximize life as in the example [symbol] . The code2GOD divine decoder further provides information on how to impact/change the past; why God created the world; why God created humanity; understand quantum mechanics; to scientifically validate events in Original Bible such as “the snake was punished by Elohim and lost the ability to walk”. The code2GOD divine decoder further provides a mechanism to scientifically understand Elohim and avoid religious rhetoric and manipulations. For example, each religious claim will have to be verified according to three parameters: last 6,000 years of history, the Original Bible, and the code2GOD.

The code2GOD divine decoder provides a decoding system as a utility to understand Yeshua as the foundation of Christianity and the validity of the Original Yeshua Testament as the holy continuation of the Original Bible as well as the proper order of books of the New Testament. For example, Yeshua name 386. The code2GOD divine decoder further provides a utility to establish the proper names assigned by God. For example, YERUSHALEM; Yitchak Yaakov multiple of 26 YHWH and provides mechanism for decoding Biblical names.

The foregoing specifications are contemplated to essentially provide a decoder tool, system and method, optionally implemented by at least one computer and a non-transitory software-based application implementable by at least one computer for deriving secondary or code2GOD meaning from a select letter string as exemplified by the original Hebrew biblical string consisting of 1,197,000 Hebrew letters devoid of spaces and punctuation.

Accordingly, if the letters of the at least one first word are re-arranged to form at least one anagram word, the at least one anagram word comprises the select word value or at least one secondary sub word value if the first select word is re-arranged and broken into a series of anagram words derived from the first select word. The word values for the first select word and its anagram(s) may be interpreted to further bolster an understanding of the primary meaning of the first select word.

The code2GOD method according to the present invention may further comprise the step of coupling the first select word value to at least one second word value to form a sequence or series of word values, which respectively can provide tertiary meaning or additional secondary or code2GOD meaning as interpreted within the context of multiple word values. The first word value and the at least one second word values may be correlated or otherwise arithmetically operated by way of a select arithmetic operator as selected from the group consisting of addition, subtraction, division and multiplication functions. The select arithmetic operator essentially outputs an arithmetically-operated word value, which arithmetically-operated word value yields or provides at least one arithmetically-operated word meaning for providing additional secondary or code2GOD meaning.

The relative or absolute position of select letters within the primary sequence of letters can be selected to form either a relative position word value or an absolute position word value. In this regard, the reader will recall that the Hebrew word or “truth” comprises the first Hebrew letter in Column 10, the last Hebrew letter in Column 10, and the 14^{th} or middle Hebrew letter in Column 10. An interpretation of the positions of these letters is that truth is not definite and can be found within the entire spectrum or listing of values associated with the listed or primary sequence of Hebrew letters. Similarly, word values may be characterized by select traits as selected from the group consisting of a mystery word value, a dominant word value, a meaningful word value, and a repetitive word value. An example of this is the value 37 which value is consistent with a normalized body temperature in Celsius degrees. Additional secondary or code2GOD meaning can be derived from these select traits.

The code2GOD system/method according to the present invention may further focus upon a select string of words as selected from a select portion of an opening stanza of the select letter string. A first letter from each word of the select string of words are associated with a first letter value, and these first letter values may be totaled or summed and further operated by dividing the total number of letters for yielding a meaningful average numerical value, which meaningful average numerical value is substantially equal to 3.14 or π. This average numerical value being substantially equal to the 3.14 or π can provide additional secondary or code2GOD meaning for the select string of words as selected from a select portion of an opening stanza of the select letter string as exemplified by the original Hebrew biblical string consisting of 1,197,000 Hebrew letters devoid of spaces and punctuation. Select word values may also be logarithmically operated to the base of Euler's number e for providing a natural logarithm for select word values for deriving additional secondary or code2GOD meaning.

The code2GOD system/method according to the present invention may further involve the summation of select numerical letter values of each letter in a select series of letters to provide a single reduced numerical value, the single reduced numerical value being either (a) between a range of values, the range of values being from 1 to 9; or (b) a select unique numerical value, the select unique numerical value being selected from the group consisting of 11, 22, 33, and 44. The single reduced numerical value can be used to derive additional secondary or code2GOD meaning for words having the same or related reduced numerical values as so reduced. It will be recalled that the reduced numerical value of 10 may represent perfection or may further reduce to a value of 1.

The code2GOD system/method according to the present invention may further focus upon a series of factors that are utilized to operate upon a select letter sub-string within the select letter string. These series of factors may comprise or consist of acronym-forming letters; select intervals of letters; and directional movement within the select letter string, the series of factors for providing additional secondary or code2GOD meaning (exemplified by DNA information). It is contemplated that a computer and a software-based application may well provide the most efficient means for deriving secondary or code2GOD meaning from portions of the original Hebrew Biblical string very much akin to the manner in which genetic traits within human DNA are located.

The code2GOD system/method according to the present invention may further focus upon the use of geometrical data to operate upon the select word value for providing additional secondary or code2GOD meaning. Geometrical data associated with the Star of David, for example, can be utilized to confirm the importance of the numerical value 37. In this regard, it will be recalled the Star of David Theorem is a mathematical result based on arithmetic properties of binomial coefficients. Comparatively referencing FIGS. 12A and 12B it will there be seen that the numbers 37 and 73 are inherently represented by the Star of David theorem, and can thus be harnessed to convey or derive secondary meaning from the original Hebrew biblical string or scripture.

The code2GOD system/method according to the present invention may further comprise the step of utilizing a select count to operate upon the select word value. The select count factor may be selected from the group consisting of a number of letters or letter number within a chosen letter string; a number of letters or letter number within related word strings; and a number of letters or letter number within a sentence. In this regard, it will be recalled the number of singular word repetitions in the original Hebrew Bible string can provide meaningful word values. Further, matching the first and last letters of a Hebrew word with the first and last letters of a verse from the original Hebrew bible string provides information for deriving additional secondary or code2GOD meaning. Further, using prime or Fibonacci numbers to explain correlations between Hebrew words or verses provides information for deriving additional secondary or code2GOD meaning.

The code2GOD system/method according to the present invention may focus upon the fact that each Hebrew letter within the primary sequence of Hebrew letters comprises a unique size and shape. The unique size and shape of each letter provides factor data, which factor data may be selected from the group consisting of letter termini data (i.e. number of end points); directional termini data (i.e. the number of end points in each of the four primary directions); and relative height-width data (the relative size of comparable Hebrew letters). The factor data can provide additional secondary or code2GOD meaning.

According to a first aspect of the presently disclosed subject matter, a computer-implemented decoder tool for deriving divine messaging is provided. The decoder tool comprises a computer-implementable software-based application, at least one computer, and a graphical user interface together being configured to: compile a Hebrew bible letter string devoid of spaces and punctuation; enable a user to input a reference Hebrew word from within the Hebrew bible letter string, the reference Hebrew word having a primary meaning; output a primary word value associated with the reference Hebrew word; and correlate the primary word value with at least one secondary word value. The user is thereby being enabled to interpret the primary meaning of the reference Hebrew word in view of the at least one secondary word value thereby providing at least one secondary meaning reflective of divine messaging from within the Hebrew bible letter string, the at least one secondary meaning for bolstering an understanding of the primary meaning.

According to another aspect of the presently disclosed subject matter, a computer-implemented system derives divine messaging. The computer-implemented system comprises a computer-implementable software-based application; at least one computer; and a Hebrew bible letter string devoid of spaces and punctuation compiled by the computer-implementable software-based application and at least one computer. The computer-implementable software-based application and the at least one computer are configured to: identify a reference Hebrew word from within the Hebrew bible letter string, the reference Hebrew word comprising a reference word value and a primary meaning; correlate the reference word value with at least one other secondary word value; and enable a user to interpret the primary meaning of the reference Hebrew word in view of the at least one secondary word value, the at least one secondary word value providing at least one secondary meaning reflective of divine messaging from within the Hebrew bible letter string, the at least one secondary meaning for bolstering an understanding of the primary meaning.

According to another aspect according to the presently disclosed subject matter, a computer-implemented method for deriving divine messaging is provided. The computer-implemented method comprises the steps of: compiling a Hebrew bible letter string devoid of spaces and punctuation by a computer-driven decoder tool, each letter within the original Hebrew bible letter string being associated with a select numerical letter value; identifying by said decoder tool a reference Hebrew word within the original Hebrew bible letter string, the reference Hebrew word having a primary meaning; assigning by said decoder tool the reference Hebrew word with a reference word value; and correlating by said decoder tool the reference word value with at least one other secondary word value. The user is thereby being enabled to interpret the primary meaning of the reference Hebrew word in view of the at least one secondary word value, the at least one secondary word value providing at least one secondary meaning reflective of divine messaging from within the Hebrew bible letter string, the at least one secondary meaning for bolstering an understanding of the primary meaning.

Accordingly, although the decoder tool, system and method according to the present invention have been described by reference to a number of different features and aspects, and optionally implementable by way of computer or machine-based means, it is not intended that the novel descriptions and systemic interactions thereof be limited thereby, but that modifications thereof are intended to be included as falling within the broad scope and spirit of the foregoing disclosure, the appended drawings, and the following claims.

What is claimed is:

1. A computer-implemented decoder tool for deriving divine messaging, said decoder tool comprising:
a computer-implementable software-based application, a computer, and a graphical user interface together being configured to:
compile a Hebrew bible letter string devoid of spaces and punctuation;
enable a user to input a reference Hebrew word from within the Hebrew bible letter string, the reference Hebrew word having a primary meaning;
output a primary word value associated with the reference Hebrew word; and
correlate the primary word value with at least one secondary word value;
a user thereby being enabled to interpret the primary meaning of the reference Hebrew word in view of the at least one secondary word value and providing at least one secondary meaning reflective of divine messaging from within the Hebrew bible letter string, the at least one secondary meaning for bolstering an understanding of the primary meaning.

2. The decoder tool according to claim 1, wherein a comparison Hebrew word is input for comparison to the reference Hebrew word, the computer-implementable software-based application, the computer, and the graphical user interface together being configured to:
output a comparison word value associated with the comparison Hebrew word;
calculate and output a word difference value derived from the primary word value and the comparison word value; and
associate the word difference value with at least one third Hebrew word;
the user thereby being enabled to interpret the primary meaning of the reference Hebrew word in view of the comparison Hebrew word and the at least one third Hebrew word thereby providing tertiary meaning reflective of divine messaging from within the Hebrew bible letter string, the tertiary meaning for bolstering an understanding of the primary meaning.

3. The decoder tool according to claim 2, wherein the computer-implementable software-based application, the computer, and the graphical user interface are together configured to:
calculate and output a word sum value derived from the primary word value and the comparison word value; and
associate the word sum value with at least one fourth Hebrew word;
the user thereby being enabled to interpret the primary meaning of the reference Hebrew word in view of the comparison Hebrew word and the at least one fourth Hebrew word thereby providing quaternary meaning reflective of divine messaging from within the Hebrew bible letter string, the quaternary meaning for bolstering an understanding of the primary meaning.

4. The decoder tool according to claim 1, wherein the reference Hebrew word consists of individual Hebrew letters, the individual Hebrew letters each being associated with a minimal letter value, the minimal letter values of each individual Hebrew letter within the reference Hebrew word being summed to provide a minimal number value upon the graphical user interface for bolstering an understanding of the primary meaning.

5. The decoder tool according to claim 4, wherein the individual Hebrew letters are associated with a letter name value, the letter name values of each individual Hebrew letter within the reference Hebrew word being summed to provide a first extended number value upon the graphical user interface for bolstering an understanding of the primary meaning.

6. The decoder tool according to claim 5, wherein select Hebrew letters of the individual Hebrew letters are associated with a plurality of letter name values, the plurality of letter name values of the select Hebrew letters being summed to provide a second extended number value upon the graphical user interface for bolstering an understanding of the primary meaning.

7. The decoder tool according to claim 6 comprising a Pi locator feature associated with output number values corresponding to any one of the primary word value, the minimal number value, the first extended number value and the second extended number value, the Pi locator feature being selected to locate a select output number value from the output number values within a Pi string at a number location therealong, the number location for bolstering an understanding of the primary meaning.

8. The decoder tool according to claim 7 configured to provide a lifepath output value, the lifepath output value being derived by summing Pi string digits from the number location along a string length equal to the select output number value, the lifepath output value for bolstering an understanding of the primary meaning.

9. The decoder tool according to claim 1, wherein a select numerical letter value of each Hebrew letter in the reference Hebrew word is summed to provide a single reduced numerical value, the single reduced numerical value being within a range of values from 1 to 9, the single reduced numerical value for bolstering an understanding of the primary meaning.

10. The decoder tool according to claim 1, wherein a verse from within the Hebrew bible letter string, and associated with the primary word value, is output upon the graphical user interface for bolstering an understanding of the primary meaning.

11. The decoder tool according to claim 1 comprising a research results add feature configured to populate a research results compilation with the reference Hebrew word as associated with the primary word value for bolstering an understanding of the primary meaning.

12. The decoder tool according to claim 11 comprising a primary word value summary feature configured to output all Hebrew words within the Hebrew bible letter string associated with the primary word value upon the graphical user interface for bolstering an understanding of the primary meaning.

13. A computer-implemented system for deriving divine messaging, the computer-implemented system comprising:
a computer-implementable software-based application; a computer; and a Hebrew bible letter string devoid of spaces and punctuation compiled by the computer-implementable software-based application and the computer;
the computer-implementable software-based application and the at least one computer being configured to:
identify a reference Hebrew word from within the Hebrew bible letter string, the reference Hebrew word comprising a reference word value and a primary meaning;
correlate the reference word value with at least one other secondary word value; and
enable a user to interpret the primary meaning of the reference Hebrew word in view of the at least one secondary word value, the at least one secondary word value providing at least one secondary meaning reflective of divine messaging from within the Hebrew bible letter string, the at least one secondary meaning for bolstering an understanding of the primary meaning.

14. The computer-implemented system according to claim 13, wherein the reference word value and each secondary word value are correlated by way of a select arithmetic operator, the select arithmetic operator being selected from the group consisting of addition, subtraction, division and multiplication, the select arithmetic operator for outputting a combination word value, the combination word value for providing at least one arithmetically-operated word meaning for bolstering an understanding of the primary meaning.

15. The computer-implemented system according to claim 13 comprising a Pi locator feature associated with at least one output number value, the Pi locator feature being selected to locate a select output number value within a Pi string at a number location therealong, the number location for bolstering an understanding of the primary meaning.

16. The computer-implemented system according to claim 13 comprising a primary word value summary feature configured to output all Hebrew words within the Hebrew bible letter string associated with the primary word value upon the graphical user interface for bolstering an understanding of the primary meaning.

17. A computer-implemented method for deriving divine messaging, the computer-implemented method comprising the steps of:
compiling a Hebrew bible letter string devoid of spaces and, each letter within the original Hebrew bible letter string being associated with a select numerical letter value;
inputting a reference Hebrew word from within the original Hebrew bible letter string into a decoder tool, the reference Hebrew word having a primary meaning;
assigning by said decoder tool the reference Hebrew word with a reference word value; and
correlating by said decoder tool the reference word value with at least one other secondary word value;
a user thereby being enabled to interpret the primary meaning of the reference Hebrew word in view of the at least one secondary word value, the at least one secondary word value providing at least one secondary meaning reflective of divine messaging from within the Hebrew bible letter string, the at least one secondary meaning for bolstering an understanding of the primary meaning.

18. The computer-implemented method according to claim 17, wherein the reference word value and each secondary word value are correlated by way of a select arithmetic operator, the select arithmetic operator being selected from the group consisting of addition, subtraction, division and multiplication, the select arithmetic operator for outputting a combination word value, the combination word value for providing at least one arithmetically-operated word meaning for bolstering an understanding of the primary meaning.

19. The computer-implemented method according to claim 17 comprising the step of selecting a Pi locator feature of said decoder tool, the Pi locator feature being selected to locate a select output number value within a Pi string at a number location therealong, the number location for bolstering an understanding of the primary meaning.

20. The computer-implemented method according to claim 17 comprising the step of outputting all Hebrew words within the Hebrew bible letter string associated with the reference word value upon a graphical user interface of said decoder tool for bolstering an understanding of the primary meaning.
